(19) United States
(12) Patent Application Publication
(10) Pub. No.: US 2022/0311536 A1
(43) Pub. Date: Sep. 29, 2022

(54) METHOD AND APPARATUS FOR RECEIVING PPDU IN BROADBAND IN WIRELESS LAN SYSTEM

(71) Applicant: LG ELECTRONICS INC., Seoul (KR)

(72) Inventors: Eunsung Park, Seoul (KR); Jinsoo Choi, Seoul (KR); Dongguk Lim, Seoul (KR)

(21) Appl. No.: 17/630,019

(22) PCT Filed: Jul. 23, 2020
(86) PCT No.: PCT/KR2020/009685

§ 371 Date: Jan. 25, 2022

(30) Foreign Application Priority Data
Aug. 12, 2019 (KR) 10-2019-0098129

(51) Int. Cl. H04L 1/00; H04W 28/20

(52) U.S. Cl. CPC H04L 1/0013; H04W 28/20; H04W 84/12

(57) ABSTRACT

Proposed are a method and apparatus for receiving a PPDU in a broadband in a wireless LAN system. Particularly, a reception STA receives a PPDU from a transmission STA through a band of 240 MHz and decodes the PPDU. The PPDU includes a control field and a data field. The control field includes information regarding a first tone plan of the band of 240 MHz. The first tone plan is set as a tone plan in which one of first through fourth bands of 80 MHz is punctured in a second tone plan of a band of 320 MHz defined in a 802.11be wireless LAN system. The second tone plan includes 12 left guard tones, 11 right guard tones, five DC tones, and a 4068-tone RU. The 4068-tone RU is an RU including 4068 tones.

### BACKGROUND OF THE DISCLOSURE

### Field of the Disclosure

The present disclosure relates to a scheme for receiving a PPDU in a wideband in a WLAN system and, more particularly, to a method and apparatus for designing a wideband tone plan and receiving a PPDU.

### Related Art

A wireless local area network (WLAN) has been improved in various ways. For example, the IEEE 802.11ax standard proposed an improved communication environment using orthogonal frequency division multiple access (OFDMA) and downlink multi-user multiple input multiple output (DL MU MIMO) techniques.

The present specification proposes a technical feature that can be utilized in a new communication standard. For example, the new communication standard may be an extreme high throughput (EHT) standard which is currently being discussed. The EHT standard may use an increased bandwidth, an enhanced PHY layer protocol data unit (PPDU) structure, an enhanced sequence, a hybrid automatic repeat request (HARQ) scheme, or the like, which is newly proposed. The EHT standard may be called the IEEE 802.11be standard.

In a new WLAN standard, an increased number of spatial streams may be used. In this case, in order to properly use the increased number of spatial streams, a signaling technique in the WLAN system may need to be improved.

### SUMMARY

The present disclosure proposes a method and apparatus for receiving a PPDU in a wideband in a WLAN system.

An example of the present disclosure proposes a method of receiving a PPDU in a wideband.

An example of the present embodiment may be performed in a Receiving STA, and may correspond to an STA supporting an extremely high throughput (EHT) WLAN system. A transmitting STA of the present embodiment may correspond to an access point (AP).

The present embodiment proposes a method of configuring a tone plan for transmitting a PPDU in a wideband (240 MHz, 320 MHz band) in an EHT WLAN system. In particular, the present embodiment proposes a method of configuring a tone plan having a 240 MHz band by performing 80 MHz puncturing on a tone plan of a 320 MHz band and transmitting and receiving PPDUs.

The Receiving Station (STA) receives a physical protocol data unit (PPDU) from the transmitting STA through the 240 MHz band.

The Receiving STA decodes the PPDU.

The PPDU includes a control field and a data field.

The control field includes information on a first tone plan of the 240 MHz band. The first tone plan is configured as a tone plan in which one of first to fourth 80 MHz bands has been punctured in a second tone plan of the 320 MHz band defined in the 802.11be WLAN system. The first tone plan may be used in order to transmit the PPDU regardless of whether the 240 MHz band is continuous or non-continuous.

The second tone plan may be a tone plan obtained by twice repeating the tone plan of the 320 MHz band, which has been newly defined in the 802.11be WLAN system, or a tone plan having the 160 MHz band, which has been newly defined in the 802.11be WLAN system. The second tone plan has been defined for throughput improvement in the case of single user (SU) transmission or if a full bandwidth is multi user-multi input multi output (MU-MIMO) transmission. Hereinafter, a case where the second tone plan is a tone plan of the 320 MHz band, which has been newly defined in the 802.11be WLAN system, is assumed and described.

The second tone plan includes 12 left guard tones, 11 right guard tones, 5 DC tones and a 4068 tone resource unit (RU). That is, the second tone plan may have the 12 left guard tones and the 11 right guard tones at both ends thereof and the 5 DC tones in the middle thereof, and the remaining band thereof may consist of the 4068 tone RU. The 4068 tone RU may include a data tone, a pilot tone and a null tone. The 4068 tone RU is an RU including 4068 tones.

### ADVANTAGEOUS EFFECTS

According to an embodiment proposed in the present disclosure, there is an effect in that efficiency of data transmission and overall throughput in a continuous or non-continuous wideband can be improved because the tone plan of the 240 MHz band is configured by applying 80 MHz band-based puncturing to the tone plan of the 320 MHz band.

### BRIEF DESCRIPTION OF THE DRAWINGS

FIG. 1 shows an example of a transmission apparatus and/or reception apparatus of this specification.

FIG. 2 is a conceptual view illustrating the structure of a wireless local area network (WLAN).

FIG. 3 illustrates a general link setup process.

FIG. 4 illustrates an example of a PPDU used in an IEEE standard.

FIG. 5 illustrates a layout of resource units (RUs) used in a band of 20 MHz.

FIG. 6 illustrates a layout of RUs used in a band of 40 MHz.

FIG. 7 illustrates a layout of RUs used in a band of 80 MHz.

FIG. 8 illustrates a structure of an HE-SIG-B field.

FIG. 9 illustrates an example in which a plurality of user STAs is allocated to the same RU through a MU-MIMO scheme.

FIG. 10 illustrates an operation based on UL-MU.

FIG. 11 illustrates an example of a trigger frame.

FIG. 12 illustrates an example of a common information field of a trigger frame.

FIG. 13 illustrates an example of a subfield included in a per user information field.

FIG. 14 describes a technical feature of the UORA scheme.

FIG. 15 illustrates an example of a channel used/supported/defined within a 2.4 GHz band.

FIG. 16 illustrates an example of a channel used/supported/defined within a 5 GHz band.

FIG. 17 illustrates an example of a channel used/supported/defined within a 6 GHz band.

FIG. 18 illustrates an example of a PPDU used in this specification.

FIG. 19 illustrates a tone plan for an 80 MHz band in an EHT WLAN system.

FIG. 20 illustrates an example of a tone plan for a 160 MHz band, which is proposed in the present embodiment.

FIG. 21 illustrates an example of a tone plan for a 320 MHz band, which is proposed in the present embodiment.

FIG. 22 is a procedure flowchart illustrating an operation of a transmission apparatus according to the present embodiment.

FIG. 23 is a procedure flowchart illustrating an operation of a reception apparatus according to the present embodiment.

FIG. 24 is a flowchart illustrating a procedure of transmitting, by a transmitting STA, a PPDU in a wideband according to the present embodiment.

FIG. 25 is a flowchart illustrating a procedure of receiving, by a Receiving STA, a PPDU in a wideband according to the present embodiment.

FIG. 26 illustrates an example of a modified transmission device and/or reception device of this specification.

### DESCRIPTION OF EXEMPLARY EMBODIMENTS

In this specification, “A or B” may mean “only A”, “only B” or “both A and B”. In other words, in this specification, “A or B” may be interpreted as “A and/or B”. For example, in this specification, “A, B, or C” may mean “only A”, “only B”, “only C”, or “any combination of A, B, C”.

A slash (/) or comma used in this specification may mean “and/or”. For example, “A/B” may mean “A and/or B”. Accordingly, “A/B” may mean “only A”, “only B”, or “both A and B”. For example, “A, B, C” may mean “A, B, or C”.

In this specification, “at least one of A and B” may mean “only A”, “only B”, or “both A and B”. In addition, in this specification, the expression “at least one of A or B” or “at least one of A and/or B” may be interpreted as “at least one of A and B”.

In addition, in this specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in this specification may mean “for example”. Specifically, when indicated as “control information (EHT-signal)”, it may mean that “EHT-signal” is proposed as an example of the “control information”. In other words, the “control information” of this specification is not limited to “EHT-signal”, and “EHT-signal” may be proposed as an example of the “control information”. In addition, when indicated as “control information (i.e., EHT-signal)”, it may also mean that “EHT-signal” is proposed as an example of the “control information”.

Technical features described individually in one figure in this specification may be individually implemented, or may be simultaneously implemented.

The following example of this specification may be applied to various wireless communication systems. For example, the following example of this specification may be applied to a wireless local area network (WLAN) system. For example, this specification may be applied to the IEEE 802.11a/g/n/ac standard or the IEEE 802.11ax standard. In addition, this specification may also be applied to the newly proposed EHT standard or IEEE 802.11be standard. In addition, the example of this specification may also be applied to a new WLAN standard enhanced from the EHT standard or the IEEE 802.11be standard. In addition, the example of this specification may be applied to a mobile communication system. For example, it may be applied to a mobile communication system based on long term evolution (LTE) depending on a 3rd generation partnership project (3GPP) standard and based on evolution of the LTE. In addition, the example of this specification may be applied to a communication system of a 5G NR standard based on the 3GPP standard.

Hereinafter, in order to describe a technical feature of this specification, a technical feature applicable to this specification will be described.

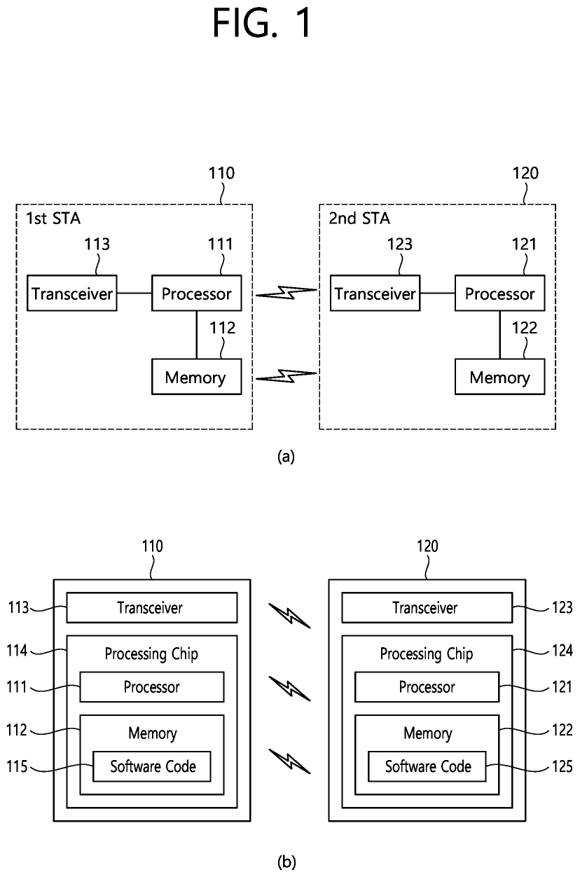

FIG. 1 shows an example of a transmission apparatus and/or reception apparatus of this specification.

In the example of FIG. 1, various technical features described below may be performed. FIG. 1 relates to at least one station (STA). For example, STAs 110 and 120 of this specification may also be called in various terms such as a mobile terminal, a wireless device, a wireless transmit/receive unit (WTRU), a user equipment (UE), a mobile station (MS), a mobile subscriber unit, or simply a user. The STAs 110 and 120 of this specification may also be called in various terms such as a network, a base station, a node-B, an access point (AP), a repeater, a router, a relay, or the like. The STAs 110 and 120 of this specification may also be referred to as various names such as a reception apparatus, a transmission apparatus, a Receiving STA, a transmitting STA, a reception device, a transmission device, or the like.

For example, the STAs 110 and 120 may serve as an AP or a non-AP. That is, the STAs 110 and 120 of this specification may serve as the AP and/or the non-AP.

STAs 110 and 120 of this specification may support various communication standards together in addition to the IEEE 802.11 standard. For example, a communication standard (e.g., LTE, LTE-A, 5G NR standard) or the like based on the 3GPP standard may be supported. In addition, the STA of this specification may be implemented as various devices such as a mobile phone, a vehicle, a personal computer, or the like. In addition, the STA of this specification may support communication for various communication services such as voice calls, video calls, data communication, and self-driving (autonomous-driving), or the like.

The STAs 110 and 120 of this specification may include a medium access control (MAC) conforming to the IEEE 802.11 standard and a physical layer interface for a radio medium.

The STAs 110 and 120 will be described below with reference to a sub-figure (a) of FIG. 1.

The first STA 110 may include a processor 111, a memory 112, and a transceiver 113. The illustrated process, memory, and transceiver may be implemented individually as separate chips, or at least two blocks/functions may be implemented through a single chip.

The transceiver 113 of the first STA performs a signal transmission/reception operation. Specifically, an IEEE 802.11 packet (e.g., IEEE 802.11a/b/g/n/ac/ax/be, etc.) may be transmitted/received.

For example, the first STA 110 may perform an operation intended by an AP. For example, the processor 111 of the AP may receive a signal through the transceiver 113, process a reception (RX) signal, generate a transmission (TX) signal, and provide control for signal transmission. The memory 112 of the AP may store a signal (e.g., RX signal) received through the transceiver 113, and may store a signal (e.g., tX signal) to be transmitted through the transceiver.

For example, the second STA 120 may perform an operation intended by a non-AP STA. For example, a transceiver 123 of a non-AP performs a signal transmission/reception operation. Specifically, an IEEE 802.11 packet (e.g., IEEE 802.11a/b/g/n/ac/ax/be packet, etc.) may be transmitted/received.

For example, a processor 121 of the non-AP STA may receive a signal through the transceiver 123, process an RX signal, generate a TX signal, and provide control for signal transmission. A memory 122 of the non-AP STA may store a signal (e.g., RX signal) received through the transceiver 123, and may store a signal (e.g., tX signal) to be transmitted through the transceiver.

For example, an operation of a device indicated as an AP in the specification described below may be performed in the first STA 110 or the second STA 120. For example, if the first STA 110 is the AP, the operation of the device indicated as the AP may be controlled by the processor 111 of the first STA 110, and a related signal may be transmitted or received through the transceiver 113 controlled by the processor 111 of the first STA 110. In addition, control information related to the operation of the AP or a TX/RX signal of the AP may be stored in the memory 112 of the first STA 110. In addition, if the second STA 120 is the AP, the operation of the device indicated as the AP may be controlled by the processor 121 of the second STA 120, and a related signal may be transmitted or received through the transceiver 123 controlled by the processor 121 of the second STA 120. In addition, control information related to the operation of the AP or a TX/RX signal of the AP may be stored in the memory 122 of the second STA 120.

For example, in the specification described below, an operation of a device indicated as a non-AP (or user-STA) may be performed in the first STA 110 or the second STA 120. For example, if the second STA 120 is the non-AP, the operation of the device indicated as the non-AP may be controlled by the processor 121 of the second STA 120, and a related signal may be transmitted or received through the transceiver 123 controlled by the processor 121 of the second STA 120. In addition, control information related to the operation of the non-AP or a TX/RX signal of the non-AP may be stored in the memory 122 of the second STA 120. For example, if the first STA 110 is the non-AP, the operation of the device indicated as the non-AP may be controlled by the processor 111 of the first STA 110, and a related signal may be transmitted or received through the transceiver 113 controlled by the processor 111 of the first STA 110. In addition, control information related to the operation of the non-AP or a TX/RX signal of the non-AP may be stored in the memory 112 of the first STA 110.

In the specification described below, a device called a (transmitting/receiving) STA, a first STA, a second STA, a STA1, a STA2, an AP, a first AP, a second AP, an AP1, an AP2, a (transmitting/receiving) terminal, a (transmitting/receiving) device, a (transmitting/receiving) apparatus, a network, or the like may imply the STAs 110 and 120 of FIG. 1. For example, a device indicated as, without a specific reference numeral, the (transmitting/receiving) STA, the first STA, the second STA, the STA1, the STA2, the AP, the first AP, the second AP, the AP1, the AP2, the (transmitting/receiving) terminal, the (transmitting/receiving) device, the (transmitting/receiving) apparatus, the network, or the like may imply the STAs 110 and 120 of FIG. 1. For example, in the following example, an operation in which various STAs transmit/receive a signal (e.g., a PPDU) may be performed in the transceivers 113 and 123 of FIG. 1. In addition, in the following example, an operation in which various STAs generate a TX/RX signal or perform data processing and computation in advance for the TX/RX signal may be performed in the processors 111 and 121 of FIG. 1. For example, an example of an operation for generating the TX/RX signal or performing the data processing and computation in advance may include: 1) an operation of determining/obtaining/configuring/computing/decoding/encoding bit information of a sub-field (SIG, STF, LTF, Data) included in a PPDU; 2) an operation of determining/configuring/obtaining a time resource or frequency resource (e.g., a subcarrier resource) or the like used for the sub-field (SIG, STF, LTF, Data) included the PPDU; 3) an operation of determining/configuring/obtaining a specific sequence (e.g., a pilot sequence, an STF/LTF sequence, an extra sequence applied to SIG) or the like used for the sub-field (SIG, STF, LTF, Data) field included in the PPDU; 4) a power control operation and/or power saving operation applied for the STA; and 5) an operation related to determining/obtaining/configuring/decoding/encoding or the like of an ACK signal. In addition, in the following example, a variety of information used by various STAs for determining/obtaining/configuring/computing/decoding/decoding a TX/RX signal (e.g., information related to a field/subfield/control field/parameter/power or the like) may be stored in the memories 112 and 122 of FIG. 1.

The aforementioned device/STA of the sub-figure (a) of FIG. 1 may be modified as shown in the sub-figure (b) of FIG. 1. Hereinafter, the STAs 110 and 120 of this specification will be described based on the sub-figure (b) of FIG. 1.

For example, the transceivers 113 and 123 illustrated in the sub-figure (b) of FIG. 1 may perform the same function as the aforementioned transceiver illustrated in the sub-figure (a) of FIG. 1. For example, processing chips 114 and 124 illustrated in the sub-figure (b) of FIG. 1 may include the processors 111 and 121 and the memories 112 and 122. The processors 111 and 121 and memories 112 and 122 illustrated in the sub-figure (b) of FIG. 1 may perform the same function as the aforementioned processors 111 and 121 and memories 112 and 122 illustrated in the sub-figure (a) of FIG. 1.

A mobile terminal, a wireless device, a wireless transmit/receive unit (WTRU), a user equipment (UE), a mobile station (MS), a mobile subscriber unit, a user, a user STA, a network, a base station, a Node-B, an access point (AP), a repeater, a router, a relay, a receiving unit, a transmitting unit, a Receiving STA, a transmitting STA, a reception device, a transmission device, a reception apparatus, and/or a transmission apparatus, which are described below, may imply the STAs 110 and 120 illustrated in the sub-figure (a)/(b) of FIG. 1, or may imply the processing chips 114 and 124 illustrated in the sub-figure (b) of FIG. 1. That is, a technical feature of this specification may be performed in the STAs 110 and 120 illustrated in the sub-figure (a)/(b) of FIG. 1, or may be performed only in the processing chips 114 and 124 illustrated in the sub-figure (b) of FIG. 1. For example, a technical feature in which the transmitting STA transmits a control signal may be understood as a technical feature in which a control signal generated in the processors 111 and 121 illustrated in the sub-figure (a)/(b) of FIG. 1 is transmitted through the transceivers 113 and 123 illustrated in the sub-figure (a)/(b) of FIG. 1. Alternatively, the technical feature in which the transmitting STA transmits the control signal may be understood as a technical feature in which the control signal to be transferred to the transceivers 113 and 123 is generated in the processing chips 114 and 124 illustrated in the sub-figure (b) of FIG. 1.

For example, a technical feature in which the Receiving STA receives the control signal may be understood as a technical feature in which the control signal is received by means of the transceivers 113 and 123 illustrated in the sub-figure (a) of FIG. 1. Alternatively, the technical feature in which the Receiving STA receives the control signal may be understood as the technical feature in which the control signal received in the transceivers 113 and 123 illustrated in the sub-figure (a) of FIG. 1 is obtained by the processors 111 and 121 illustrated in the sub-figure (a) of FIG. 1. Alternatively, the technical feature in which the Receiving STA receives the control signal may be understood as the technical feature in which the control signal received in the transceivers 113 and 123 illustrated in the sub-figure (b) of FIG. 1 is obtained by the processing chips 114 and 124 illustrated in the sub-figure (b) of FIG. 1.

Referring to the sub-figure (b) of FIG. 1, software codes 115 and 125 may be included in the memories 112 and 122. The software codes 115 and 126 may include instructions for controlling an operation of the processors 111 and 121. The software codes 115 and 125 may be included as various programming languages.

The processors 111 and 121 or processing chips 114 and 124 of FIG. 1 may include an application-specific integrated circuit (ASIC), other chipsets, a logic circuit and/or a data processing device. The processor may be an application processor (AP). For example, the processors 111 and 121 or processing chips 114 and 124 of FIG. 1 may include at least one of a digital signal processor (DSP), a central processing unit (CPU), a graphics processing unit (GPU), and a modulator and demodulator (modem). For example, the processors 111 and 121 or processing chips 114 and 124 of FIG. 1 may be SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or processors enhanced from these processors.

In this specification, an uplink may imply a link for communication from a non-AP STA to an SP STA, and an uplink PPDU/packet/signal or the like may be transmitted through the uplink. In addition, in this specification, a downlink may imply a link for communication from the AP STA to the non-AP STA, and a downlink PPDU/packet/signal or the like may be transmitted through the downlink.

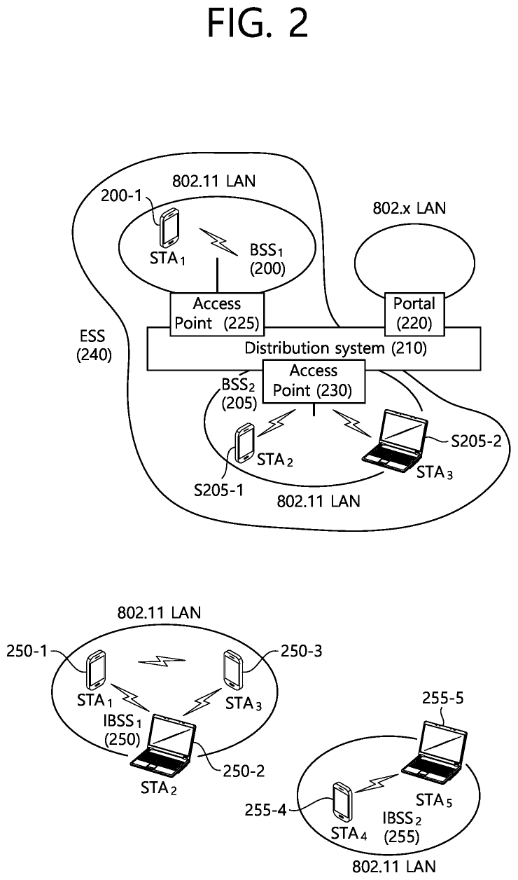

FIG. 2 is a conceptual view illustrating the structure of a wireless local area network (WLAN).

An upper part of FIG. 2 illustrates the structure of an infrastructure basic service set (BSS) of institute of electrical and electronic engineers (i.e.EE) 802.11.

Referring the upper part of FIG. 2, the wireless LAN system may include one or more infrastructure BSSs 200 and 205 (hereinafter, referred to as BSS). The BSSs 200 and 205 as a set of an AP and a STA such as an access point (AP) 225 and a station (STA1) 200-1 which are successfully synchronized to communicate with each other are not concepts indicating a specific region. The BSS 205 may include one or more STAs 205-1 and 205-2 which may be joined to one AP 230.

The BSS may include at least one STA, APs providing a distribution service, and a distribution system (DS) 210 connecting multiple APs.

The distribution system 210 may implement an extended service set (ESS) 240 extended by connecting the multiple BSSs 200 and 205. The ESS 240 may be used as a term indicating one network configured by connecting one or more APs 225 or 230 through the distribution system 210. The AP included in one ESS 240 may have the same service set identification (SSID).

A portal 220 may serve as a bridge which connects the wireless LAN network (i.e.EE 802.11) and another network (e.g., 802.X).

In the BSS illustrated in the upper part of FIG. 2, a network between the APs 225 and 230 and a network between the APs 225 and 230 and the STAs 200-1, 205-1, and 205-2 may be implemented. However, the network is configured even between the STAs without the APs 225 and 230 to perform communication. A network in which the communication is performed by configuring the network even between the STAs without the APs 225 and 230 is defined as an Ad-Hoc network or an independent basic service set (IBSS).

A lower part of FIG. 2 illustrates a conceptual view illustrating the IBSS.

Referring to the lower part of FIG. 2, the IBSS is a BSS that operates in an Ad-Hoc mode. Since the IBSS does not include the access point (AP), a centralized management entity that performs a management function at the center does not exist. That is, in the IBSS, STAs 250-1, 250-2, 250-3, 255-4, and 255-5 are managed by a distributed manner. In the IBSS, all STAs 250-1, 250-2, 250-3, 255-4, and 255-5 may be constituted by movable STAs and are not permitted to access the DS to constitute a self-contained network.

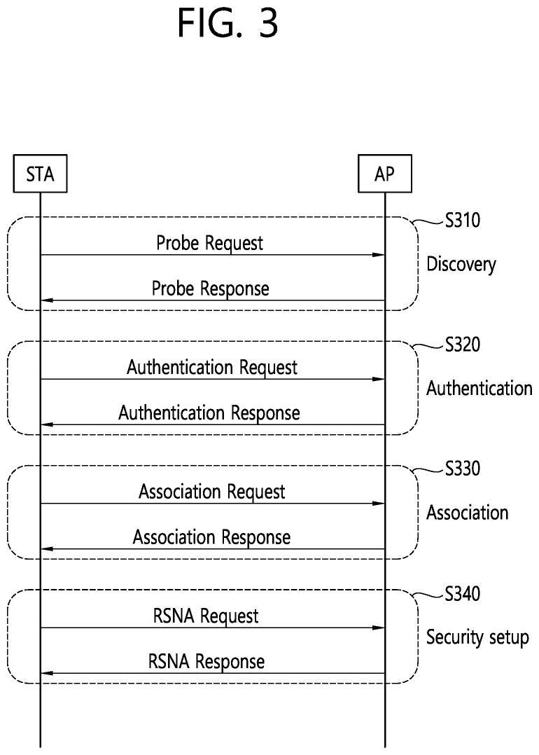

FIG. 3 illustrates a general link setup process.

In S310, a STA may perform a network discovery operation. The network discovery operation may include a scanning operation of the STA. That is, to access a network, the STA needs to discover a participating network. The STA needs to identify a compatible network before participating in a wireless network, and a process of identifying a network present in a particular area is referred to as scanning. Scanning methods include active scanning and passive scanning.

FIG. 3 illustrates a network discovery operation including an active scanning process. In active scanning, a STA performing scanning transmits a probe request frame and waits for a response to the probe request frame in order to identify which AP is present around while moving to channels. A responder transmits a probe response frame as a response to the probe request frame to the STA having transmitted the probe request frame. Here, the responder may be a STA that transmits the last beacon frame in a BSS of a channel being scanned. In the BSS, since an AP transmits a beacon frame, the AP is the responder. In an IBSS, since STAs in the IBSS transmit a beacon frame in turns, the responder is not fixed. For example, when the STA transmits a probe request frame via channel 1 and receives a probe response frame via channel 1, the STA may store BSS-related information included in the received probe response frame, may move to the next channel (e.g., channel 2), and may perform scanning (e.g., transmits a probe request and receives a probe response via channel 2) by the same method.

Although not shown in FIG. 3, scanning may be performed by a passive scanning method. In passive scanning, a STA performing scanning may wait for a beacon frame while moving to channels. A beacon frame is one of management frames in IEEE 802.11 and is periodically transmitted to indicate the presence of a wireless network and to enable the STA performing scanning to find the wireless network and to participate in the wireless network. In a BSS, an AP serves to periodically transmit a beacon frame. In an IBSS, STAs in the IBSS transmit a beacon frame in turns. Upon receiving the beacon frame, the STA performing scanning stores information about a BSS included in the beacon frame and records beacon frame information in each channel while moving to another channel. The STA having received the beacon frame may store BSS-related information included in the received beacon frame, may move to the next channel, and may perform scanning in the next channel by the same method.

After discovering the network, the STA may perform an authentication process in S320. The authentication process may be referred to as a first authentication process to be clearly distinguished from the following security setup operation in S340. The authentication process in S320 may include a process in which the STA transmits an authentication request frame to the AP and the AP transmits an authentication response frame to the STA in response. The authentication frames used for an authentication request/response are management frames.

The authentication frames may include information about an authentication algorithm number, an authentication transaction sequence number, a status code, a challenge text, a robust security network (RSN), and a finite cyclic group.

The STA may transmit the authentication request frame to the AP. The AP may determine whether to allow the authentication of the STA based on the information included in the received authentication request frame. The AP may provide the authentication processing result to the STA via the authentication response frame.

When the STA is successfully authenticated, the STA may perform an association process in S330. The association process includes a process in which the STA transmits an association request frame to the AP and the AP transmits an association response frame to the STA in response. The association request frame may include, for example, information about various capabilities, a beacon listen interval, a service set identifier (SSID), a supported rate, a supported channel, RSN, a mobility domain, a supported operating class, a traffic indication map (TIM) broadcast request, and an interworking service capability. The association response frame may include, for example, information about various capabilities, a status code, an association ID (AID), a supported rate, an enhanced distributed channel access (EDCA) parameter set, a received channel power indicator (RCPI), a received signal-to-noise indicator (RSNI), a mobility domain, a timeout interval (association comeback time), an overlapping BSS scanning parameter, a TIM broadcast response, and a QoS map.

In S340, the STA may perform a security setup process. The security setup process in S340 may include a process of setting up a private key through four-way handshaking, for example, through an extensible authentication protocol over LAN (EAPOL) frame.

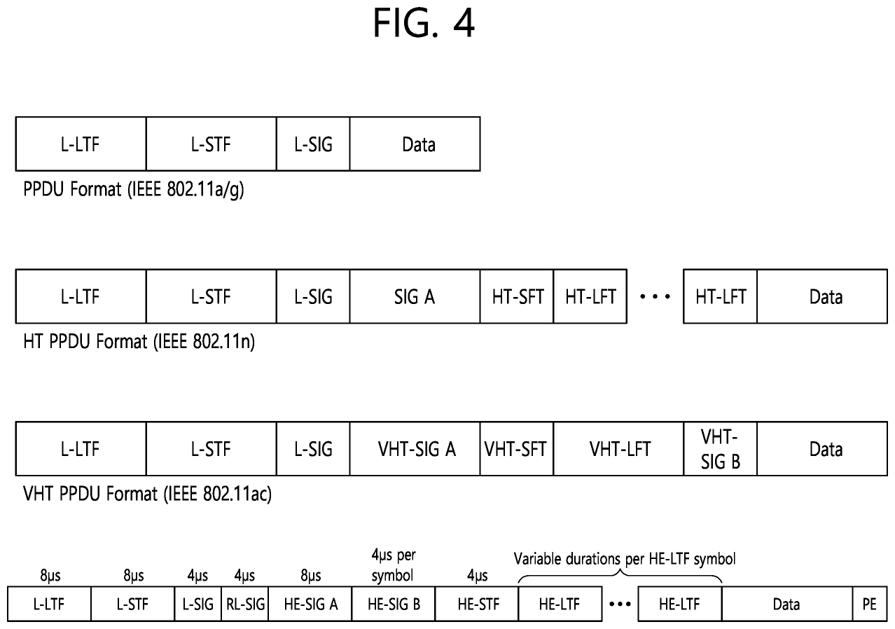

FIG. 4 illustrates an example of a PPDU used in an IEEE standard.

As illustrated, various types of PHY protocol data units (PPDUs) are used in IEEE a/g/n/ac standards. Specifically, an LTF and a STF include a training signal, a SIG-A and a SIG-B include control information for a Receiving STA, and a data field includes user data corresponding to a PSDU (MAC PDU/aggregated MAC PDU).

FIG. 4 also includes an example of an HE PPDU according to IEEE 802.11ax. The HE PPDU according to FIG. 4 is an illustrative PPDU for multiple users. An HE-SIG-B may be included only in a PPDU for multiple users, and an HE-SIG-B may be omitted in a PPDU for a single user.

As illustrated in FIG. 4, the HE-PPDU for multiple users (MUs) may include a legacy-short training field (L-STF), a legacy-long training field (L-LTF), a legacy-signal (L-SIG), a high efficiency-signal A (HE-SIG A), a high efficiency-signal-B (HE-SIG B), a high efficiency-short training field (HE-STF), a high efficiency-long training field (HE-LTF), a data field (alternatively, an MAC payload), and a packet extension (PE) field. The respective fields may be transmitted for illustrated time periods (i.e., 4 or 8 μs).

Hereinafter, a resource unit (RU) used for a PPDU is described. An RU may include a plurality of subcarriers (or tones). An RU may be used to transmit a signal to a plurality of STAs according to OFDMA. Further, an RU may also be defined to transmit a signal to one STA. An RU may be used for an STF, an LTF, a data field, or the like.

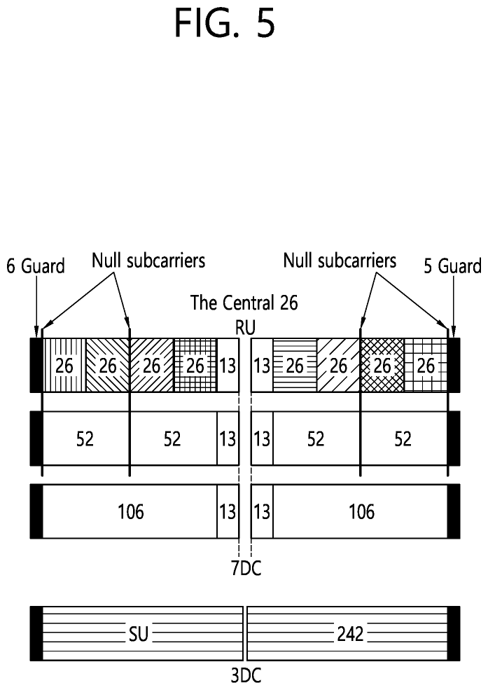

FIG. 5 illustrates a layout of resource units (RUs) used in a band of 20 MHz.

As illustrated in FIG. 5, resource units (RUs) corresponding to different numbers of tones (i.e., subcarriers) may be used to form some fields of an HE-PPDU. For example, resources may be allocated in illustrated RUs for an HE-STF, an HE-LTF, and a data field.

As illustrated in the uppermost part of FIG. 5, a 26-unit (i.e., a unit corresponding to 26 tones) may be disposed. Six tones may be used for a guard band in the leftmost band of the 20 MHz band, and five tones may be used for a guard band in the rightmost band of the 20 MHz band. Further, seven DC tones may be inserted in a center band, that is, a DC band, and a 26-unit corresponding to 13 tones on each of the left and right sides of the DC band may be disposed. A 26-unit, a 52-unit, and a 106-unit may be allocated to other bands. Each unit may be allocated for a Receiving STA, that is, a user.

The layout of the RUs in FIG. 5 may be used not only for multiple users (MUs) but also for a single user (SU), in which case one 242-unit may be used and three DC tones may be inserted as illustrated in the lowermost part of FIG. 5.

Although FIG. 5 proposes RUs having various sizes, that is, a 26-RU, a 52-RU, a 106-RU, and a 242-RU, specific sizes of RUs may be extended or increased. Therefore, the present embodiment is not limited to the specific size of each RU (i.e., the number of corresponding tones).

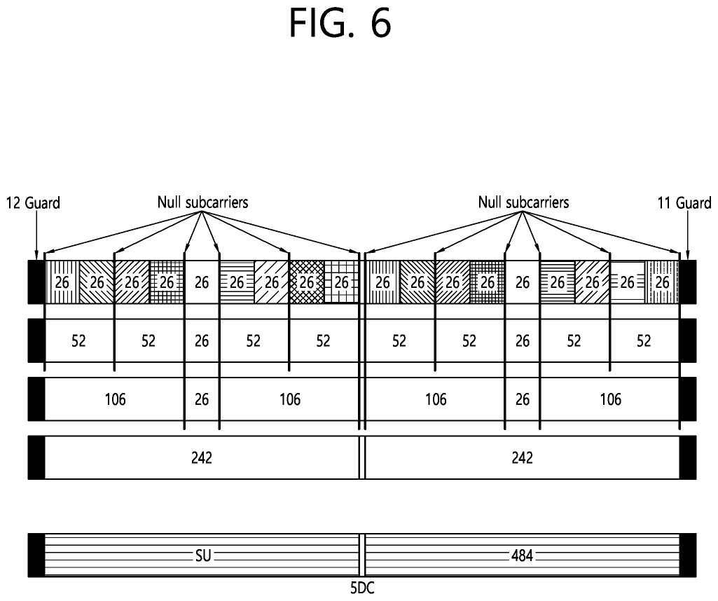

FIG. 6 illustrates a layout of RUs used in a band of 40 MHz.

Similarly to FIG. 5 in which RUs having various sizes are used, a 26-RU, a 52-RU, a 106-RU, a 242-RU, a 484-RU, and the like may be used in an example of FIG. 6. Further, five DC tones may be inserted in a center frequency, 12 tones may be used for a guard band in the leftmost band of the 40 MHz band, and 11 tones may be used for a guard band in the rightmost band of the 40 MHz band.

As illustrated in FIG. 6, when the layout of the RUs is used for a single user, a 484-RU may be used. The specific number of RUs may be changed similarly to FIG. 5.

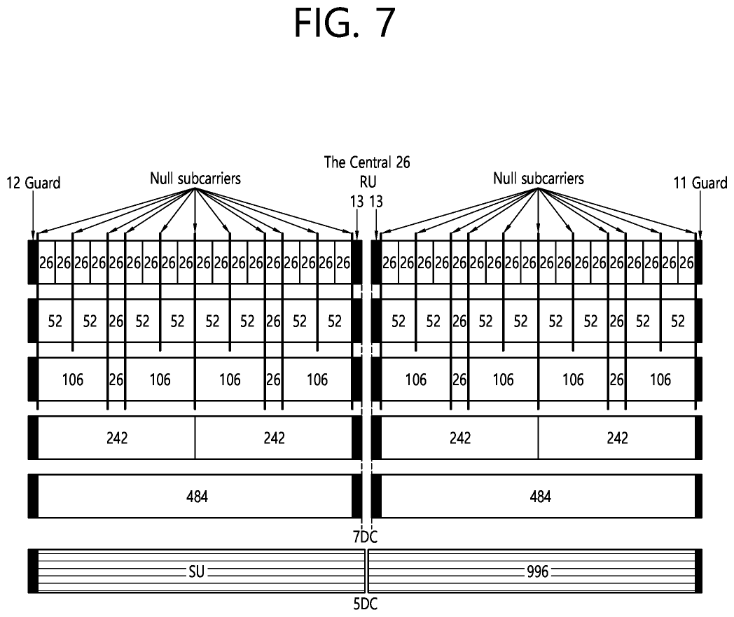

FIG. 7 illustrates a layout of RUs used in a band of 80 MHz.

Similarly to FIG. 5 and FIG. 6 in which RUs having various sizes are used, a 26-RU, a 52-RU, a 106-RU, a 242-RU, a 484-RU, a 996-RU, and the like may be used in an example of FIG. 7. Further, seven DC tones may be inserted in the center frequency, 12 tones may be used for a guard band in the leftmost band of the 80 MHz band, and 11 tones may be used for a guard band in the rightmost band of the 80 MHz band. In addition, a 26-RU corresponding to 13 tones on each of the left and right sides of the DC band may be used.

As illustrated in FIG. 7, when the layout of the RUs is used for a single user, a 996-RU may be used, in which case five DC tones may be inserted.

The RU described in this specification may be used in uplink (UL) communication and downlink (DL) communication. For example, when UL-MU communication which is solicited by a trigger frame is performed, a transmitting STA (e.g., an AP) may allocate a first RU (e.g., 26/52/106/242-RU, etc.) to a first STA through the trigger frame, and may allocate a second RU (e.g., 26/52/106/242-RU, etc.) to a second STA. Thereafter, the first STA may transmit a first trigger-based PPDU based on the first RU, and the second STA may transmit a second trigger-based PPDU based on the second RU. The first/second trigger-based PPDU is transmitted to the AP at the same (or overlapped) time period.

For example, when a DL MU PPDU is configured, the transmitting STA (e.g., AP) may allocate the first RU (e.g., 26/52/106/242-RU. etc.) to the first STA, and may allocate the second RU (e.g., 26/52/106/242-RU, etc.) to the second STA. That is, the transmitting STA (e.g., AP) may transmit HE-STF, HE-LTF, and Data fields for the first STA through the first RU in one MU PPDU, and may transmit HE-STF, HE-LTF, and Data fields for the second STA through the second RU.

Information related to a layout of the RU may be signaled through HE-SIG-B.

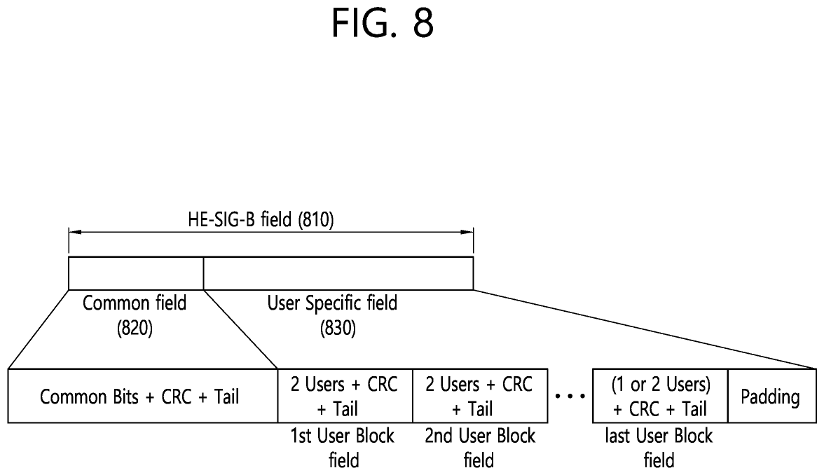

FIG. 8 illustrates a structure of an HE-SIG-B field.

As illustrated, an HE-SIG-B field 810 includes a common field 820 and a user-specific field 830. The common field 820 may include information commonly applied to all users (i.e., user STAs) which receive SIG-B. The user-specific field 830 may be called a user-specific control field. When the SIG-B is transferred to a plurality of users, the user-specific field 830 may be applied only any one of the plurality of users.

As illustrated in FIG. 8, the common field 820 and the user-specific field 830 may be separately encoded.

The common field 820 may include RU allocation information of N*8 bits. For example, the RU allocation information may include information related to a location of an RU. For example, when a 20 MHz channel is used as shown in FIG. 5, the RU allocation information may include information related to a specific frequency band to which a specific RU (26-RU/52-RU/106-RU) is arranged.

An example of a case in which the RU allocation information consists of 8 bits is as follows.

TABLE 1

| RU Allocation | | | | | | | | | | |
|---|---|---|---|---|---|---|---|---|---|---|
| subfield | | | | | | | | | | |
| (B7 B6 B5 B4 | | | | | | | | | | Number |
| B3 B2 B1 B0) | #1 | #2 | #3 | #4 | #5 | #6 | #7 | #8 | #9 | of entries |
| 00000000 | 26 | 26 | 26 | 26 | 26 | 26 | 26 | 26 | 26 | 1 |

| | | | | | | | | | |
|---|---|---|---|---|---|---|---|---|---|
| 00000001 | 26 | 26 | 26 | 26 | 26 | 26 | 26 | 52 | 1 |

| | | | | | | | | | |
|---|---|---|---|---|---|---|---|---|---|
| 00000010 | 26 | 26 | 26 | 26 | 26 | 52 | 26 | 26 | 1 |

| | | | | | | | | |
|---|---|---|---|---|---|---|---|---|
| 00000011 | 26 | 26 | 26 | 26 | 26 | 52 | 52 | 1 |

| | | | | | | | | | |
|---|---|---|---|---|---|---|---|---|---|
| 00000100 | 26 | 26 | 52 | 26 | 26 | 26 | 26 | 26 | 1 |

| | | | | | | | | |
|---|---|---|---|---|---|---|---|---|
| 00000101 | 26 | 26 | 52 | 26 | 26 | 26 | 52 | 1 |

| | | | | | | | | |
|---|---|---|---|---|---|---|---|---|
| 00000110 | 26 | 26 | 52 | 26 | 52 | 26 | 26 | 1 |

| | | | | | | | |
|---|---|---|---|---|---|---|---|
| 00000111 | 26 | 26 | 52 | 26 | 52 | 52 | 1 |

| | | | | | | | | | |
|---|---|---|---|---|---|---|---|---|---|
| 00001000 | 52 | 26 | 26 | 26 | 26 | 26 | 26 | 26 | 1 |

| | | | | | | | | |
|---|---|---|---|---|---|---|---|---|
| 00001001 | 52 | 26 | 26 | 26 | 26 | 26 | 52 | 1 |

| | | | | | | | | |
|---|---|---|---|---|---|---|---|---|
| 00001010 | 52 | 26 | 26 | 26 | 52 | 26 | 26 | 1 |

As shown the example of FIG. 5, up to nine 26-RUs may be allocated to the 20 MHz channel. When the RU allocation information of the common field 820 is set to “00000000” as shown in Table 1, the nine 26-RUs may be allocated to a corresponding channel (i.e., 20 MHz). In addition, when the RU allocation information of the common field 820 is set to “00000001” as shown in Table 1, seven 26-RUs and one 52-RU are arranged in a corresponding channel. That is, in the example of FIG. 5, the 52-RU may be allocated to the rightmost side, and the seven 26-RUs may be allocated to the left thereof.

The example of Table 1 shows only some of RU locations capable of displaying the RU allocation information.

For example, the RU allocation information may include an example of Table 2 below.

TABLE 2

| 8 bits indices | | | | | | | | | | |
|---|---|---|---|---|---|---|---|---|---|---|
| (B7 B6 B5 B4 | | | | | | | | | | Number |
| B3 B2 B1 B0) | #1 | #2 | #3 | #4 | #5 | #6 | #7 | #8 | #9 | of entries |

| | | | | | | | |
|---|---|---|---|---|---|---|---|
| 01000y₂y₁y₀ | 106 | 26 | 26 | 26 | 26 | 26 | 8 |

| | | | | | | |
|---|---|---|---|---|---|---|
| 01001y₂y₁y₀ | 106 | 26 | 26 | 26 | 52 | 8 |

“01000y2y1y0” relates to an example in which a 106-RU is allocated to the leftmost side of the 20 MHz channel, and five 26-RUs are allocated to the right side thereof. In this case, a plurality of STAs (e.g., user-STAs) may be allocated to the 106-RU, based on a MU-MIMO scheme. Specifically, up to 8 STAs (e.g., user-STAs) may be allocated to the 106-RU, and the number of STAs (e.g., user-STAs) allocated to the 106-RU is determined based on 3-bit information (y2y1y0). For example, when the 3-bit information (y2y1y0) is set to N, the number of STAs (e.g., user-STAs) allocated to the 106-RU based on the MU-MIMO scheme may be N+1.

In general, a plurality of STAs (e.g., user STAs) different from each other may be allocated to a plurality of RUs. However, the plurality of STAs (e.g., user STAs) may be allocated to one or more RUs having at least a specific size (e.g., 106 subcarriers), based on the MU-MIMO scheme.

As shown in FIG. 8, the user-specific field 830 may include a plurality of user fields. As described above, the number of STAs (e.g., user STAs) allocated to a specific channel may be determined based on the RU allocation information of the common field 820. For example, when the RU allocation information of the common field 820 is “00000000”, one user STA may be allocated to each of nine 26-RUs (e.g., nine user STAs may be allocated). That is, up to 9 user STAs may be allocated to a specific channel through an OFDMA scheme. In other words, up to 9 user STAs may be allocated to a specific channel through a non-MU-MIMO scheme.

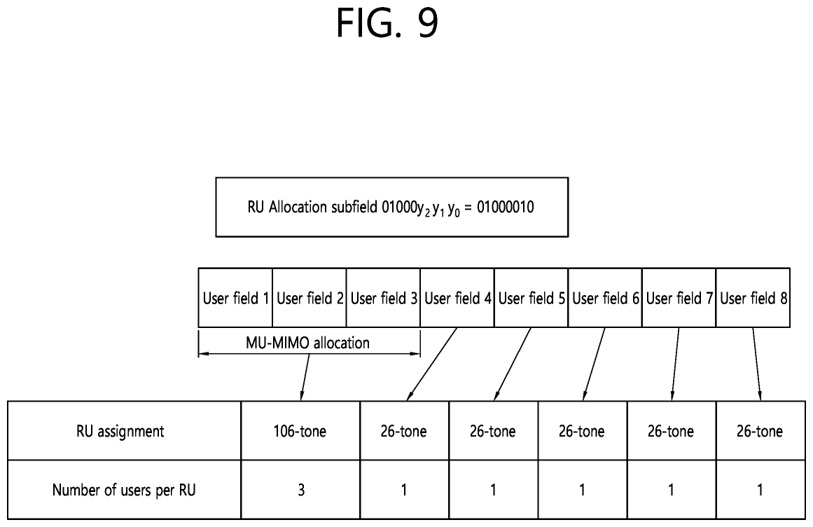

For example, when RU allocation is set to “01000y2y1y0”, a plurality of STAs may be allocated to the 106-RU arranged at the leftmost side through the MU-MIMO scheme, and five user STAs may be allocated to five 26-RUs arranged to the right side thereof through the non-MU MIMO scheme. This case is specified through an example of FIG. 9.

FIG. 9 illustrates an example in which a plurality of user STAs are allocated to the same RU through a MU-MIMO scheme.

For example, when RU allocation is set to “01000010” as shown in FIG. 9, a 106-RU may be allocated to the leftmost side of a specific channel, and five 26-RUs may be allocated to the right side thereof. In addition, three user STAs may be allocated to the 106-RU through the MU-MIMO scheme. As a result, since eight user STAs are allocated, the user-specific field 830 of HE-SIG-B may include eight user fields.

The eight user fields may be expressed in the order shown in FIG. 9. In addition, as shown in FIG. 8, two user fields may be implemented with one user block field.

The user fields shown in FIG. 8 and FIG. 9 may be configured based on two formats. That is, a user field related to a MU-MIMO scheme may be configured in a first format, and a user field related to a non-MIMO scheme may be configured in a second format. Referring to the example of FIG. 9, a user field 1 to a user field 3 may be based on the first format, and a user field 4 to a user field 8 may be based on the second format. The first format or the second format may include bit information of the same length (e.g., 21 bits).

Each user field may have the same size (e.g., 21 bits). For example, the user field of the first format (the first of the MU-MIMO scheme) may be configured as follows.

For example, a first bit (i.e., B0-B10) in the user field (i.e., 21 bits) may include identification information (e.g., STA-ID, partial AID, etc.) of a user STA to which a corresponding user field is allocated. In addition, a second bit (i.e., B11-B14) in the user field (i.e., 21 bits) may include information related to a spatial configuration. Specifically, an example of the second bit (i.e., B11-B14) may be as shown in Table 3 and Table 4 below.

TABLE 3

| | | N_{STS} | N_{STS} | N_{STS} | N_{STS} | N_{STS} | N_{STS} | N_{STS} | N_{STS} | Total | Number |
|---|---|---|---|---|---|---|---|---|---|---|---|
| Nᵤₛₑᵣ | B3 . . . B0 | [1] | [2] | [3] | [4] | [5] | [6] | [7] | [8] | N_{STS} | of entries |
| 2 | 0000-0011 | 1-4 | 1 | | | | | | | 2-5 | 10 |
| | 0100-0110 | 2-4 | 2 | | | | | | | 4-6 | |
| | 0111-1000 | 3-4 | 3 | | | | | | | 6-7 | |
| | 1001 | 4 | 4 | | | | | | | 8 | |
| 3 | 0000-0011 | 1-4 | 1 | 1 | | | | | | 3-6 | 13 |
| | 0100-0110 | 2-4 | 2 | 1 | | | | | | 5-7 | |
| | 0111-1000 | 3-4 | 3 | 1 | | | | | | 7-8 | |
| | 1001-1011 | 2-4 | 2 | 2 | | | | | | 6-8 | |
| | 1100 | 3 | 3 | 2 | | | | | | 8 | |
| 4 | 0000-0011 | 1-4 | 1 | 1 | 1 | | | | | 4-7 | 11 |
| | 0100-0110 | 2-4 | 2 | 1 | 1 | | | | | 6-8 | |
| | 0111 | 3 | 3 | 1 | 1 | | | | | 8 | |
| | 1000-1001 | 2-3 | 2 | 2 | 1 | | | | | 7-8 | |
| | 1010 | 2 | 2 | 2 | 2 | | | | | 8 | |

TABLE 4

| | | N_{STS} | N_{STS} | N_{STS} | N_{STS} | N_{STS} | N_{STS} | N_{STS} | N_{STS} | Total | Number |
|---|---|---|---|---|---|---|---|---|---|---|---|
| Nᵤₛₑᵣ | B3 . . . B0 | [1] | [2] | [3] | [4] | [5] | [6] | [7] | [8] | N_{STS} | of entries |
| 5 | 0000-0011 | 1-4 | 1 | 1 | 1 | 1 | | | | 5-8 | 7 |
| | 0100-0101 | 2-3 | 2 | 1 | 1 | 1 | | | | 7-8 | |
| | 0110 | 2 | 2 | 2 | 1 | 1 | | | | 8 | |
| 6 | 0000-0010 | 1-3 | 1 | 1 | 1 | 1 | 1 | | | 6-8 | 4 |
| | 0011 | 2 | 2 | 1 | 1 | 1 | 1 | | | 8 | |
| 7 | 0000-0001 | 1-2 | 1 | 1 | 1 | 1 | 1 | 1 | | 7-8 | 2 |
| 8 | 0000 | 1 | 1 | 1 | 1 | 1 | 1 | 1 | 1 | 8 | 1 |

As shown in Table 3 and/or Table 4, the second bit (e.g., B11-B14) may include information related to the number of spatial streams allocated to the plurality of user STAs which are allocated based on the MU-MIMO scheme. For example, when three user STAs are allocated to the 106-RU based on the MU-MIMO scheme as shown in FIG. 9, N_user is set to “3”. Therefore, values of N_STS[1], N_STS[2], and N_STS[3] may be determined as shown in Table 3. For example, when a value of the second bit (B11-B14) is “0011”, it may be set to N_STS[1]=4, N_STS[2]=1, N_STS[3]=1. That is, in the example of FIG. 9, four spatial streams may be allocated to the user field 1, one spatial stream may be allocated to the user field 1, and one spatial stream may be allocated to the user field 3.

As shown in the example of Table 3 and/or Table 4, information (i.e., the second bit, B11-B14) related to the number of spatial streams for the user STA may consist of 4 bits. In addition, the information (i.e., the second bit, B11-B14) on the number of spatial streams for the user STA may support up to eight spatial streams. In addition, the information (i.e., the second bit, B11-B14) on the number of spatial streams for the user STA may support up to four spatial streams for one user STA.

In addition, a third bit (i.e., B15-18) in the user field (i.e., 21 bits) may include modulation and coding scheme (MCS) information. The MCS information may be applied to a data field in a PPDU including corresponding SIG-B.

An MCS, MCS information, an MCS index, an MCS field, or the like used in this specification may be indicated by an index value. For example, the MCS information may be indicated by an index 0 to an index 11. The MCS information may include information related to a constellation modulation type (e.g., BPSK, QPSK, 16-QAM, 64-QAM, 256-QAM, 1024-QAM, etc.) and information related to a coding rate (e.g., 1/2, 2/3, 3/4, 5/6e, etc.). Information related to a channel coding type (e.g., LCC or LDPC) may be excluded in the MCS information.

In addition, a fourth bit (i.e., B19) in the user field (i.e., 21 bits) may be a reserved field.

In addition, a fifth bit (i.e., B20) in the user field (i.e., 21 bits) may include information related to a coding type (e.g., BCC or LDPC). That is, the fifth bit (i.e., B20) may include information related to a type (e.g., BCC or LDPC) of channel coding applied to the data field in the PPDU including the corresponding SIG-B.

The aforementioned example relates to the user field of the first format (the format of the MU-MIMO scheme). An example of the user field of the second format (the format of the non-MU-MIMO scheme) is as follows.

A first bit (e.g., B0-B10) in the user field of the second format may include identification information of a user STA. In addition, a second bit (e.g., B11-B13) in the user field of the second format may include information related to the number of spatial streams applied to a corresponding RU. In addition, a third bit (e.g., B14) in the user field of the second format may include information related to whether a beamforming steering matrix is applied. A fourth bit (e.g., B15-B18) in the user field of the second format may include modulation and coding scheme (MCS) information. In addition, a fifth bit (e.g., B19) in the user field of the second format may include information related to whether dual carrier modulation (DCM) is applied. In addition, a sixth bit (i.e., B20) in the user field of the second format may include information related to a coding type (e.g., BCC or LDPC).

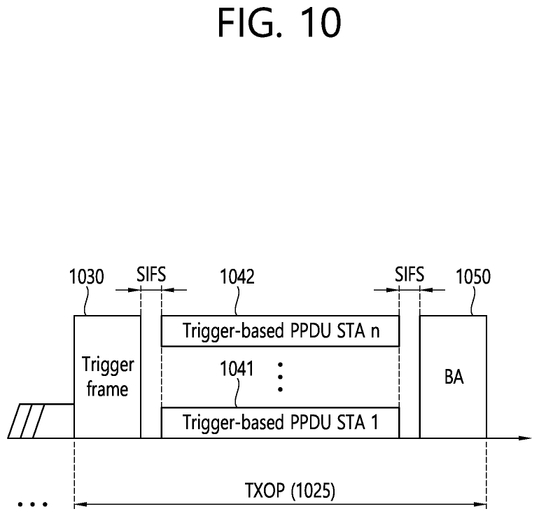

FIG. 10 illustrates an operation based on UL-MU. As illustrated, a transmitting STA (e.g., an AP) may perform channel access through contending (e.g., a backoff operation), and may transmit a trigger frame 1030. That is, the transmitting STA may transmit a PPDU including the trigger frame 1030. Upon receiving the PPDU including the trigger frame, a trigger-based (TB) PPDU is transmitted after a delay corresponding to SIFS.

TB PPDUs 1041 and 1042 may be transmitted at the same time period, and may be transmitted from a plurality of STAs (e.g., user STAs) having AIDs indicated in the trigger frame 1030. An ACK frame 1050 for the TB PPDU may be implemented in various forms.

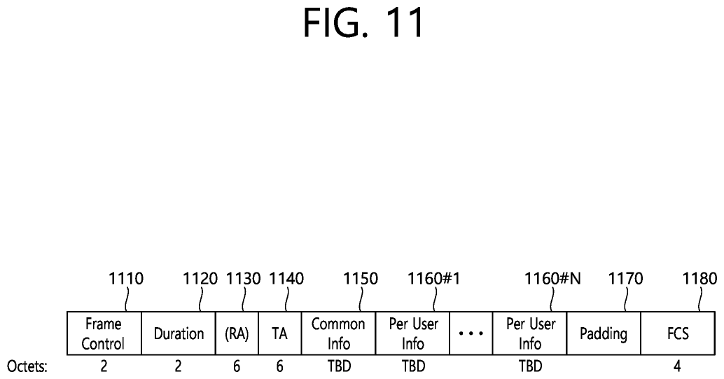

A specific feature of the trigger frame is described with reference to FIG. 11 to FIG. 13. Even if UL-MU communication is used, an orthogonal frequency division multiple access (OFDMA) scheme or a MU MIMO scheme may be used, and the OFDMA and MU-MIMO schemes may be simultaneously used.

FIG. 11 illustrates an example of a trigger frame. The trigger frame of FIG. 11 allocates a resource for uplink multiple-user (MU) transmission, and may be transmitted, for example, from an AP. The trigger frame may be configured of a MAC frame, and may be included in a PPDU.

Each field shown in FIG. 11 may be partially omitted, and another field may be added. In addition, a length of each field may be changed to be different from that shown in the figure.

A frame control field 1110 of FIG. 11 may include information related to a MAC protocol version and extra additional control information. A duration field 1120 may include time information for NAV configuration or information related to an identifier (e.g., AID) of a STA.

In addition, an RA field 1130 may include address information of a Receiving STA of a corresponding trigger frame, and may be optionally omitted. A TA field 1140 may include address information of a STA (e.g., an AP) which transmits the corresponding trigger frame. A common information field 1150 includes common control information applied to the Receiving STA which receives the corresponding trigger frame. For example, a field indicating a length of an L-SIG field of an uplink PPDU transmitted in response to the corresponding trigger frame or information for controlling content of a SIG-A field (i.e., HE-SIG-A field) of the uplink PPDU transmitted in response to the corresponding trigger frame may be included. In addition, as common control information, information related to a length of a CP of the uplink PPDU transmitted in response to the corresponding trigger frame or information related to a length of an LTF field may be included.

In addition, per user information fields 1160#1 to 1160#N corresponding to the number of Receiving STAs which receive the trigger frame of FIG. 11 are preferably included. The per user information field may also be called an “allocation field”.

In addition, the trigger frame of FIG. 11 may include a padding field 1170 and a frame check sequence field 1180.

Each of the per user information fields 1160#1 to 1160#N shown in FIG. 11 may include a plurality of subfields.

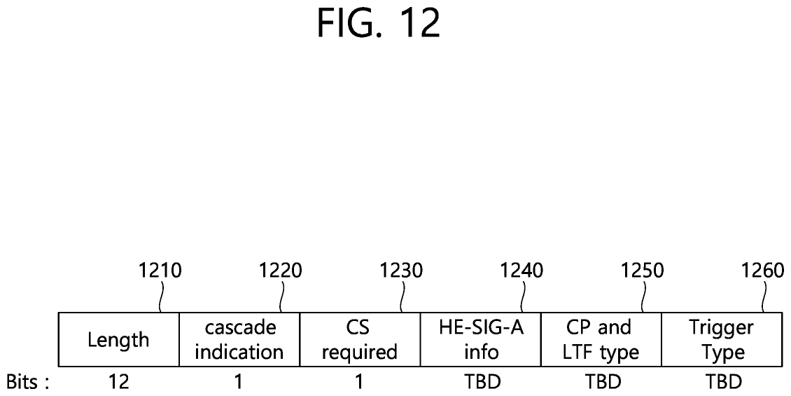

FIG. 12 illustrates an example of a common information field of a trigger frame. A subfield of FIG. 12 may be partially omitted, and an extra subfield may be added. In addition, a length of each subfield illustrated may be changed.

A length field 1210 illustrated has the same value as a length field of an L-SIG field of an uplink PPDU transmitted in response to a corresponding trigger frame, and a length field of the L-SIG field of the uplink PPDU indicates a length of the uplink PPDU. As a result, the length field 1210 of the trigger frame may be used to indicate the length of the corresponding uplink PPDU.

In addition, a cascade identifier field 1220 indicates whether a cascade operation is performed. The cascade operation implies that downlink MU transmission and uplink MU transmission are performed together in the same TXOP. That is, it implies that downlink MU transmission is performed and thereafter uplink MU transmission is performed after a pre-set time (e.g., SIFS). During the cascade operation, only one transmission device (e.g., AP) may perform downlink communication, and a plurality of transmission devices (e.g., non-APs) may perform uplink communication.

A CS request field 1230 indicates whether a wireless medium state or a NAV or the like is necessarily considered in a situation where a reception device which has received a corresponding trigger frame transmits a corresponding uplink PPDU.

An HE-SIG-A information field 1240 may include information for controlling content of a SIG-A field (i.e., HE-SIG-A field) of the uplink PPDU in response to the corresponding trigger frame.

A CP and LTF type field 1250 may include information related to a CP length and LTF length of the uplink PPDU transmitted in response to the corresponding trigger frame. A trigger type field 1260 may indicate a purpose of using the corresponding trigger frame, for example, typical triggering, triggering for beamforming, a request for block ACK/NACK, or the like.

It may be assumed that the trigger type field 1260 of the trigger frame in this specification indicates a trigger frame of a basic type for typical triggering. For example, the trigger frame of the basic type may be referred to as a basic trigger frame.

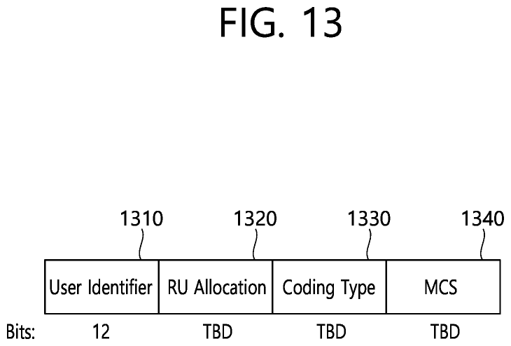

FIG. 13 illustrates an example of a subfield included in a per user information field. A user information field 1300 of FIG. 13 may be understood as any one of the per user information fields 1160#1 to 1160#N mentioned above with reference to FIG. 11. A subfield included in the user information field 1300 of FIG. 13 may be partially omitted, and an extra subfield may be added. In addition, a length of each subfield illustrated may be changed.

A user identifier field 1310 of FIG. 13 indicates an identifier of a STA (i.e., Receiving STA) corresponding to per user information. An example of the identifier may be the entirety or part of an association identifier (AID) value of the Receiving STA.

In addition, an RU allocation field 1320 may be included. That is, when the Receiving STA identified through the user identifier field 1310 transmits a TB PPDU in response to the trigger frame, the TB PPDU is transmitted through an RU indicated by the RU allocation field 1320. In this case, the RU indicated by the RU allocation field 1320 may be an RU shown in FIG. 5, FIG. 6, and FIG. 7.

The subfield of FIG. 13 may include a coding type field 1330. The coding type field 1330 may indicate a coding type of the TB PPDU. For example, when BCC coding is applied to the TB PPDU, the coding type field 1330 may be set to ‘1’, and when LDPC coding is applied, the coding type field 1330 may be set to ‘0’.

In addition, the subfield of FIG. 13 may include an MCS field 1340. The MCS field 1340 may indicate an MCS scheme applied to the TB PPDU. For example, when BCC coding is applied to the TB PPDU, the coding type field 1330 may be set to ‘1’, and when LDPC coding is applied, the coding type field 1330 may be set to ‘0’.

Hereinafter, a UL OFDMA-based random access (UORA) scheme will be described.

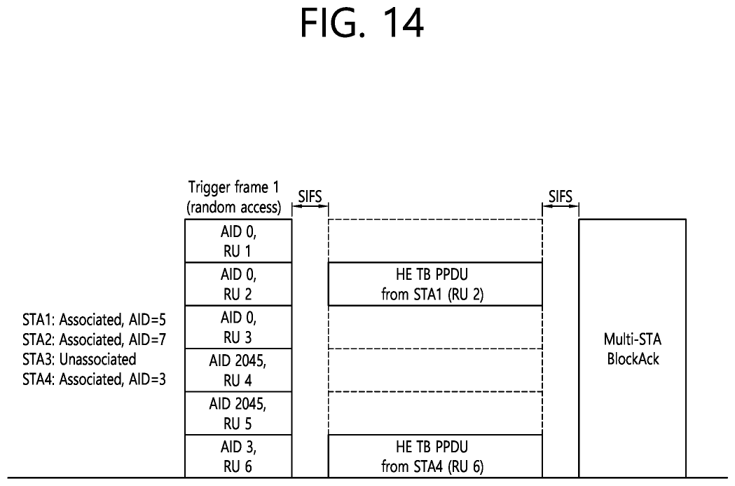

FIG. 14 describes a technical feature of the UORA scheme.

A transmitting STA (e.g., an AP) may allocate six RU resources through a trigger frame as shown in FIG. 14. Specifically, the AP may allocate a 1st RU resource (AID 0, RU 1), a 2nd RU resource (AID 0, RU 2), a 3rd RU resource (AID 0, RU 3), a 4th RU resource (AID 2045, RU 4), a 5th RU resource (AID 2045, RU 5), and a 6th RU resource (AID 3, RU 6). Information related to the AID 0, AID 3, or AID 2045 may be included, for example, in the user identifier field 1310 of FIG. 13. Information related to the RU 1 to RU 6 may be included, for example, in the RU allocation field 1320 of FIG. 13. AID=0 may imply a UORA resource for an associated STA, and AID=2045 may imply a UORA resource for an un-associated STA. Accordingly, the 1st to 3rd RU resources of FIG. 14 may be used as a UORA resource for the associated STA, the 4th and 5th RU resources of FIG. 14 may be used as a UORA resource for the un-associated STA, and the 6th RU resource of FIG. 14 may be used as a typical resource for UL MU.

In the example of FIG. 14, an OFDMA random access backoff (OBO) of a STA1 is decreased to 0, and the STA1 randomly selects the 2nd RU resource (AID 0, RU 2). In addition, since an OBO counter of a STA2/3 is greater than 0, an uplink resource is not allocated to the STA2/3. In addition, regarding a STA4 in FIG. 14, since an AID (e.g., AID=3) of the STA4 is included in a trigger frame, a resource of the RU 6 is allocated without backoff.

Specifically, since the STA1 of FIG. 14 is an associated STA, the total number of eligible RA RUs for the STA1 is 3 (RU 1, RU 2, and RU 3), and thus the STA1 decreases an OBO counter by 3 so that the OBO counter becomes 0. In addition, since the STA2 of FIG. 14 is an associated STA, the total number of eligible RA RUs for the STA2 is 3 (RU 1, RU 2, and RU 3), and thus the STA2 decreases the OBO counter by 3 but the OBO counter is greater than 0. In addition, since the STA3 of FIG. 14 is an un-associated STA, the total number of eligible RA RUs for the STA3 is 2 (RU 4, RU 5), and thus the STA3 decreases the OBO counter by 2 but the OBO counter is greater than 0.

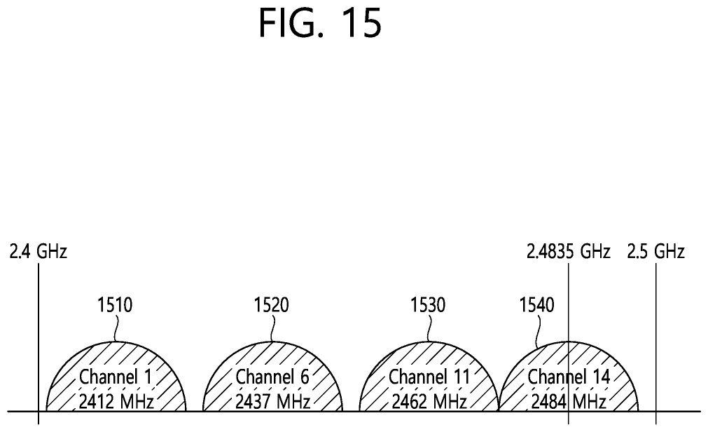

FIG. 15 illustrates an example of a channel used/supported/defined within a 2.4 GHz band.

The 2.4 GHz band may be called in other terms such as a first band. In addition, the 2.4 GHz band may imply a frequency domain in which channels of which a center frequency is close to 2.4 GHz (e.g., channels of which a center frequency is located within 2.4 to 2.5 GHz) are used/supported/defined.

A plurality of 20 MHz channels may be included in the 2.4 GHz band. 20 MHz within the 2.4 GHz may have a plurality of channel indices (e.g., an index 1 to an index 14). For example, a center frequency of a 20 MHz channel to which a channel index 1 is allocated may be 2.412 GHz, a center frequency of a 20 MHz channel to which a channel index 2 is allocated may be 2.417 GHz, and a center frequency of a 20 MHz channel to which a channel index N is allocated may be (2.407+0.005*N) GHz. The channel index may be called in various terms such as a channel number or the like. Specific numerical values of the channel index and center frequency may be changed.

FIG. 15 exemplifies 4 channels within a 2.4 GHz band. Each of 1st to 4th frequency domains 1510 to 1540 shown herein may include one channel. For example, the 1st frequency domain 1510 may include a channel 1 (a 20 MHz channel having an index 1). In this case, a center frequency of the channel 1 may be set to 2412 MHz. The 2nd frequency domain 1520 may include a channel 6. In this case, a center frequency of the channel 6 may be set to 2437 MHz. The 3rd frequency domain 1530 may include a channel 11. In this case, a center frequency of the channel 11 may be set to 2462 MHz. The 4th frequency domain 1540 may include a channel 14. In this case, a center frequency of the channel 14 may be set to 2484 MHz.

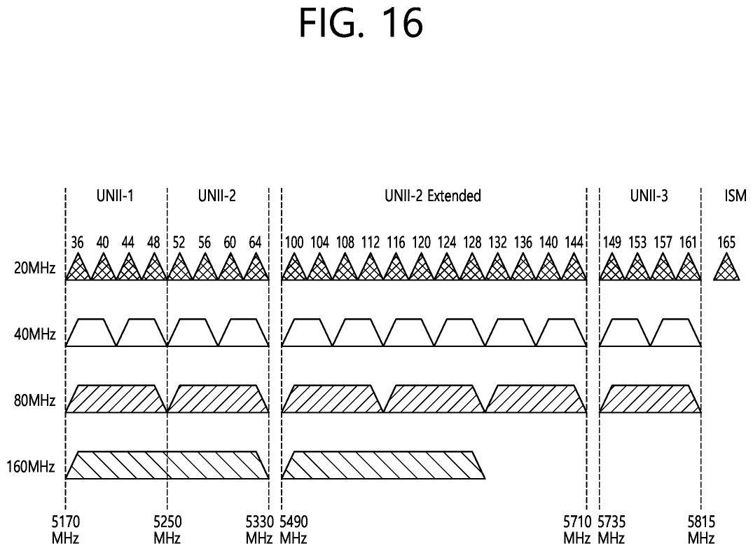

FIG. 16 illustrates an example of a channel used/supported/defined within a 5 GHz band.

The 5 GHz band may be called in other terms such as a second band or the like. The 5 GHz band may imply a frequency domain in which channels of which a center frequency is greater than or equal to 5 GHz and less than 6 GHz (or less than 5.9 GHz) are used/supported/defined. Alternatively, the 5 GHz band may include a plurality of channels between 4.5 GHz and 5.5 GHz. A specific numerical value shown in FIG. 16 may be changed.

A plurality of channels within the 5 GHz band include an unlicensed national information infrastructure (UNII)-1, a UNII-2, a UNII-3, and an ISM. The INII-1 may be called UNII Low. The UNII-2 may include a frequency domain called UNII Mid and UNII-2Extended. The UNII-3 may be called UNII-Upper.

A plurality of channels may be configured within the 5 GHz band, and a bandwidth of each channel may be variously set to, for example, 20 MHz, 40 MHz, 80 MHz, 160 MHz, or the like. For example, 5170 MHz to 5330 MHz frequency domains/ranges within the UNII-1 and UNII-2 may be divided into eight 20 MHz channels. The 5170 MHz to 5330 MHz frequency domains/ranges may be divided into four channels through a 40 MHz frequency domain. The 5170 MHz to 5330 MHz frequency domains/ranges may be divided into two channels through an 80 MHz frequency domain. Alternatively, the 5170 MHz to 5330 MHz frequency domains/ranges may be divided into one channel through a 160 MHz frequency domain.

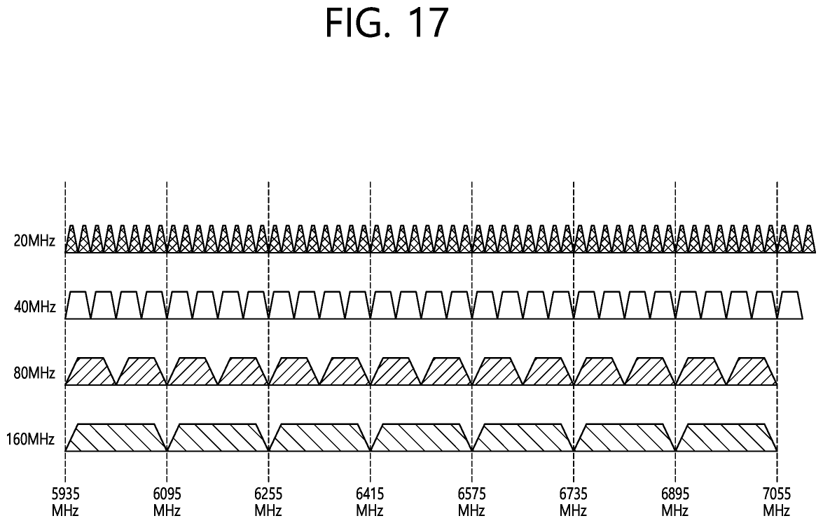

FIG. 17 illustrates an example of a channel used/supported/defined within a 6 GHz band.

The 6 GHz band may be called in other terms such as a third band or the like. The 6 GHz band may imply a frequency domain in which channels of which a center frequency is greater than or equal to 5.9 GHz are used/supported/defined. A specific numerical value shown in FIG. 17 may be changed.

For example, the 20 MHz channel of FIG. 17 may be defined starting from 5.940 GHz. Specifically, among 20 MHz channels of FIG. 17, the leftmost channel may have an index 1 (or a channel index, a channel number, etc.), and 5.945 GHz may be assigned as a center frequency. That is, a center frequency of a channel of an index N may be determined as (5.940+0.005*N) GHz.

Accordingly, an index (or channel number) of the 2 MHz channel of FIG. 17 may be 1, 5, 9, 13, 17, 21, 25, 29, 33, 37, 41, 45, 49, 53, 57, 61, 65, 69, 73, 77, 81, 85, 89, 93, 97, 101, 105, 109, 113, 117, 121, 125, 129, 133, 137, 141, 145, 149, 153, 157, 161, 165, 169, 173, 177, 181, 185, 189, 193, 197, 201, 205, 209, 213, 217, 221, 225, 229, 233. In addition, according to the aforementioned (5.940+0.005*N) GHz rule, an index of the 40 MHz channel of FIG. 17 may be 3, 11, 19, 27, 35, 43, 51, 59, 67, 75, 83, 91, 99, 107, 115, 123, 131, 139, 147, 155, 163, 171, 179, 187, 195, 203, 211, 219, 227.

Although 20, 40, 80, and 160 MHz channels are illustrated in the example of FIG. 17, a 240 MHz channel or a 320 MHz channel may be additionally added.

Hereinafter, a PPDU transmitted/received in a STA of this specification will be described.

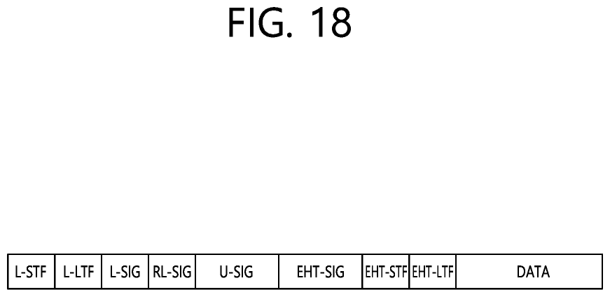

FIG. 18 illustrates an example of a PPDU used in this specification.

The PPDU of FIG. 18 may be referred to as various terms, such as EHT PPDU, transmitting PPDU, receiving PPDU, first type or Nth type PPDU, and so on. For example, in this specification, PPDU or EHT PPDU may be referred to by using various terms, such as transmission PPDU, reception PPDU, first type or Nth type PPDU, and so on. Additionally, the EHT PPDU may be used in an EHT system and/or a new WLAN system, which is an enhanced version of the EHT system.

The PPDU of FIG. 18 may represent part or all of a PPDU type that is used in an EHT system. For example, the example of FIG. 18 may be used for both single-user (SU) mode and multi-user (MU) mode, or may be used only for the SU mode, or may be used only for the MU mode. For example, in the EHT system, a trigger-based (TB) PPDU may be separately defined or may be configured based on an example of FIG. 18. A trigger frame and UL-MU operations that are started by the trigger frame (e.g., transmitting operations of the TB PPDU), which are described by at least one of FIG. 10 to FIG. 14, may be directly applied to the EHT system without modification.

In FIG. 18, L-STF to EHT-LTF may be referred to as a preamble or physical preamble, and the L-STF to EHT-LTF may be generated/transmitted/received/obtained/decoded in a physical layer.

Subcarrier spacing of the L-LTF, L-STF, L-SIG, RL-SIG, U-SIG, and EHT-SIG fields of FIG. 18 may be determined as 312.5 kHz, and subcarrier spacing of the EHT-STF, EHT-LTF, Data fields may be determined as 78.125 kHz. That is, tone indexes (or subcarrier indexes) of the L-STF, L-LTF, L-SIG, RL-SIG, U-SIG, and EHT-SIG fields may be indicated in 312.5 kHz units, and tone indexes (or subcarrier indexes) of the EHT-STF, EHT-LTF, Data fields may be indicated in 78.125 kHz units.

In the PPDU of FIG. 18, L-LTF and L-STF may be the same as the fields of the prior art (or related art).

The L-SIG field of FIG. 18 may, for example, include 24 bits of bit information. For example, the 24-bit information may include a 4-bit Rate field, 1 Reserved bit, a 12-bit Length field, 1 Parity bit, and 6 Tail bits. For example, the 12-bit Length field may include information related to a PPDU length or time duration. For example, a value of the 12-bit Length field may be determined based on a type of the PPDU. For example, in case the PPDU is a non-HT PPDU, an HT PPDU, a VHT PPDU, or an EHT PPDU, the value of the Length field may be determined as a multiple of 3. For example, in case the PPDU is an HE PPDU, the value of the Length field may be determined as “a multiple of 3+1” or “a multiple of 3+2”. In other words, a value of the Length field for a non-HT PPDU, an HT PPDU, a VHT PPDU, or an EHT PPDU may be determined as a multiple of 3, and a value of the Length field for an HE PPDU may be determined as “a multiple of 3+1” or “a multiple of 3+2”.

For example, a transmitting STA may apply BCC encoding, which is based on a 1/2-code rate for 24-bit information of the L-SIG field. Afterwards, the transmitting STA may obtain 48 bits of BCC encoding bits. Then, BPSK modulation may be applied to the 48 encoding bits so as to generate 48 BPSK symbols. The transmitting STA may map the 48 BPSK symbols to positions excluding a pilot subcarrier {Subcarrier indexes −21, −7, +7, +21} and a DC subcarrier {Subcarrier index 0}. As a result, the 48 BPSK symbols may be mapped to subcarrier indexes −26 to −22, −20 to −8, −6 to −1, +1 to +6, +8 to +20, and +22 to +26. The transmitting STA may additionally map a signal of {−1, −1, −1, 1} to subcarrier indexes {−28, −27, +27, +28}. The aforementioned signal may be used for channel estimation for a frequency domain corresponding to {−28, −27, +27, +28}.

The transmitting STA may generate an RL-SIG, which is generated identically as the L-SIG. The Receiving STA may know that the reception PPDU is an HE PPDU or EHT PPDU based on the presence (or existence) of an RL-SIG.

A Universal SIG (U-SIG) may be inserted after the RL-SIG of FIG. 18. The U-SIG may also be referred to by using various terms, such as a first SIG field, a first SIG, a first-type SIG, a control signal, a control signal field, a first (type) control signal, and so on.

The U-SIG may include N-bit information and may also include information for identifying the EHT PPDU type. For example, the U-SIG may be configured based on 2 symbols (e.g., two contiguous OFDM symbols). Each symbol (e.g., OFDM symbol) for the U-SIG may have a duration of 4 us. Each symbol of the U-SIG may be used for transmitting 26-bit information. For example, each symbol of the U-SIG may be transmitted/received based on 52 data tones and 4 pilot tones.

For example, A-bit information (e.g., 52 un-coded bits) may be transmitted through the U-SIG (or U-SIG field), and a first symbol of the U-SIG may transmit first X-bit information (e.g., 26 un-coded bits) among the total of A bits of the corresponding information, and a second symbol of the U-SIG may transmit remaining Y-bit information (e.g., 26 un-coded bits) of the A-bit information. For example, the transmitting STA may obtain 26 un-coded bits that are included in each U-SIG symbol. The transmitting STA may perform convolutional encoding (i.e., BCC encoding) based on a rate of R=½ so as to generate 52-coded bits, and, then, the transmitting STA may perform interleaving on the 52-coded bits. The transmitting STA may perform BPSK modulation on the interleaved 52-coded bits, so as to generate 52 BPSK symbols that are allocated to each U-SIG symbol. One U-SIG symbol may be transmitted based on 56 tones (subcarriers) starting from subcarrier index −28 to subcarrier index +28, with the exception for DC index 0. The 52 BPSK symbols that are generated by the transmitting STA may be transmitted based on the remaining tones (subcarriers) excluding the pilot tones −21, −7, +7, +21 tones.

For example, the A-bit information (e.g., 52 un-coded bits) may include a CRC field (e.g., 4-bit length field) and a Tail field (e.g., 6-bit length field). The CRC field and the Tail field may be transmitted through the second symbol of the U-SIG. The CRC field may be generated based on the 26 bits being allocated to the first symbol of the U-SIG and the remaining 16 bits excluding the CRC/Tail fields from the second symbol. And, the CRC field may be generated based on the related art CRC calculation algorithm. Additionally, the Tail field may be used for terminating a trellis of a convolutional decoder and may, for example, be configured as “000000”.

The A-bit information (e.g., 52 un-coded bits) being transmitted by the U-SIG (or U-SIG field) may be divided into version-independent bits and version-dependent bits. For example, a size of the version-independent bits may be fixed or variable. For example, the version-independent bits may be allocated only to the first symbol of the U-SIG or may be allocated to both the first and second symbols of the U-SIG. For example, the version-independent bits and the version-dependent bits may be referred to by using various terms, such as a first control bit and a second control bit.

For example, the version-independent bits of the U-SIG may include a 3-bit PHY version identifier. For example, the 3-bit PHY version identifier may include information related to the PHY version of the transmission/reception PPDU. For example, a first value of the 3-bit PHY version identifier may indicate that the transmission/reception PPDU is an EHT PPDU. In other words, when the transmitting STA transmits the EHT PPDU, the transmitting STA may set the 3-bit PHY version identifier to the first value. In other words, based on the PHY version identifier having the first value, the Receiving STA may determine that the reception PPDU is an EHT PPDU.

For example, the version-independent bits of the U-SIG may include a 1-bit UL/DL flag field. A first value of the 1-bit UL/DL flag field is related to UL communication, and a second value of the 1-bit UL/DL flag field is related to DL communication.

For example, the version-independent bits of the U-SIG may include information related to the length of a TXOP, and information related to BSS color ID.

For example, in case the EHT PPDU is divided into various types (e.g., EHT PPDU related to SU mode, EHT PPDU related to MU mode, EHT PPDU related to a TriggerFrame, EHT PPDU related to Extended Range transmission, and so on), information related to the EHT PPDU type may be included in the version-dependent bits of the U-SIG.

For example, the U-SIG may include information related to 1) a bandwidth field including information related to a bandwidth, 2) a field including information related to an MCS scheme being applied to the EHT-SIG, 3) an indication field including information related to whether or not a dual subcarrier modulation (DCM) scheme is applied to the EHT-SIG, 4) a field including information related to a number of symbols being used for the EHT-SIG, 5) a field including information related to whether or not the EHT-SIG is generated throughout the whole band, 6) a field including information related to an EHT-LTF/STF type, 7) a field indicating an EHT-LTF length and a CP length.

Preamble puncturing may be applied to the PPDU of FIG. 18. Preamble puncturing means applying puncturing to a partial band (e.g., a Secondary 20 MHz band) of the whole band of a PPDU. For example, when an 80 MHz PPDU is transmitted, the STA may apply puncturing to a secondary 20 MHz band of the 80 MHz band and may transmit the PPDU only through a primary 20 MHz band and a secondary 40 MHz band.

For example, a pattern of preamble puncturing may be preset (or predetermined). For example, when a first puncturing pattern is applied, the puncturing may be applied only for a secondary 20 MHz band within the 80 MHz band. For example, when a second puncturing pattern is applied, the puncturing may be applied to only one of the two secondary 20 MHz bands that are included in the secondary 40 MHz band within the 80 MHz band. For example, when a third puncturing pattern is applied, the puncturing may be applied only to a secondary 20 MHz band that is included in a primary 80 MHz band within a 160 MHz band (or 80+80 MHz band). For example, when a fourth puncturing pattern is applied, and when a primary 40 MHz band that is included in a primary 80 MHz band within a 160 MHz band (or 80+80 MHz band) is present, the puncturing may be applied to at least one 20 MHz channel that does not belong to the primary 40 MHz band.

Information related to the preamble puncturing that is applied to the PPDU may be included in the U-SIG and/or EHT-SIG. For example, a first field of the U-SIG may include information related to a contiguous bandwidth of the PPDU, and a second field of the U-SIG may include information related to preamble puncturing that is applied to the PPDU.

For example, the U-SIG and EHT-SIG may include information related to preamble puncturing based on the following method. When the bandwidth of a PPDU exceeds 80 MHz, the U-SIG may be separately configured in 80 MHz units. For example, when the bandwidth of a PPDU is 160 MHz, a first U-SIG for a first 80 MHz band and a second U-SIG for a second 80 MHz band may be included in the corresponding PPDU. In this case, a first field of the first U-SIG may include information related to the 160 MHz bandwidth, and a second field of the first U-SIG may include information related to preamble puncturing (i.e., information related to a preamble puncturing pattern) that is applied to the first 80 MHz band. Additionally, a first field of the second U-SIG may include information related to the 160 MHz bandwidth, and a second field of the second U-SIG may include information related to preamble puncturing (i.e., information related to a preamble puncturing pattern) that is applied to the second 80 MHz band. Meanwhile, an EHT-SIG that is contiguous to the first U-SIG may include information related to preamble puncturing (i.e., information related to a preamble puncturing pattern) that is applied to the second 80 MHz band, and an EHT-SIG that is contiguous to the second U-SIG may include information related to preamble puncturing (i.e., information related to a preamble puncturing pattern) that is applied to the first 80 MHz band.

Additionally or alternatively, the U-SIG and EHT-SIG may include information related to preamble puncturing based on the following method. The U-SIG may include information related to preamble puncturing (i.e., information related to a preamble puncturing pattern) for all bands. That is, the EHT-SIG may not include information related to preamble puncturing, and only the U-SIG may include information related to preamble puncturing (i.e., information related to a preamble puncturing pattern).

The U-SIG may be configured of 20 MHz units. For example, when an 80 MHz PPDU is configured, the U-SIG may be duplicated. That is, 4 identical U-SIGs may be included in the 80 MHz PPDU. A PPDU that exceeds the 80 MHz bandwidth may include different U-SIGs.

The EHT-SIG of FIG. 18 may include the technical features of an HE-SIG-B, which is indicated in the examples of FIG. 8 to FIG. 9, as they are. The EHT-SIG may also be referred to by using various terms, such as a second SIG field, a second SIG, a second-type SIG, a control signal, a control signal field, a second (type) control signal, and so on.

The EHT-SIG may include N-bit information (e.g., 1-bit information) related to whether an EHT PPDU supports the SU mode or whether an EHT PPDU supports the MU mode.

The EHT-SIG may be configured based on various MCS schemes. As described above, the information related to the MCS scheme being applied to the EHT-SIG may be included in the U-SIG. The EHT-SIG may be configured based on a DCM scheme. For example, among N number of data tones (e.g., 52 data tones) that are allocated for the EHT-SIG, a first modulation scheme may be applied to one half of contiguous tones, and a second modulation scheme may be applied to the remaining half of contiguous tones. That is, the transmitting STA may modulate specific control information to a first symbol based on the first modulation scheme and may allocate the modulated first symbol to one half of contiguous tones. Thereafter, the transmitting STA may modulate the same control information to a second symbol based on the second modulation scheme and may allocated the modulated second symbol to the other half of contiguous tones. As described above, information related to whether or not the DCM scheme is applied to the EHT-SIG (e.g., 1 bit field) may be included in the U-SIG. EHT-STF of FIG. 18 may be used for enhancing automatic gain control estimation in a multiple input multiple output (MIMO) environment or OFDMA environment. And, EHT-LTF of FIG. 18 may be used for estimating a channel in a MIMO environment or OFDMA environment.

The EHT-STF may be set to various types. For example, among the STFs, a first type (i.e., 1× STF) may be generated based on a first type STF sequence in which non-zero coefficients are positioned at 16 subcarrier spacings. An STF signal that is generated based on the first type STF sequence may have aperiodicity (or cycle period) of 0.8 μs. And, the signal having the periodicity of 0.8 μs may be repeated 5 times and become a first type STF having a length of 4 μs. For example, among the STFs, a second type (i.e., 2× STF) may be generated based on a second type STF sequence in which non-zero coefficients are positioned at 8 subcarrier spacings. An STF signal that is generated based on the second type STF sequence may have aperiodicity (or cycle period) of 1.6 μs. And, the signal having the periodicity of 1.6 μs may be repeated 5 times and become a second type STF having a length of 8 μs. Hereinafter, an example of a sequence (i.e., EHT-STF sequence) for configuring an EHT-STF will be proposed. The following sequence may be modified to various types.

The EHT-STF may be configured based on the following M sequence.

M={−1, −1, −1, 1, 1, 1, −1, 1, 1, 1, −1, 1, 1, −1, 1} <Equation 1>

An EHT-STF for a 20 MHz PPDU may be configured based on the following equation. The example shown below may be a first type (i.e., 1× STF) sequence. For example, the first type sequence may be included in an EHT-PPDU and not a trigger-based (TB) PPDU. In the following equation, (a:b:c) may denote durations being defined at b tone spacings (i.e., subcarrier spacings) starting from an a tone index (i.e., subcarrier index) to a c tone index. For example, Equation 2 shown below may represent a sequence that is defined at 16 tone spacings starting from tone index −112 to tone index 112. For an EHT-STF, since subcarrier spacing of 78.125 kHz is applied, the 16 tone spacings may mean that EHT-STF coefficients (or elements) are positioned at 78.125*16=1250 kHz intervals (or spacings). Additionally, * means multiplication (i.e., ‘multiplied by’), and sqrt( ) means square root.

EHT-STF(−112:16:112)={M}*(1+j)/sqrt(2)

EHT-STF(0)=0 <Equation 2>

An EHT-STF for a 40 MHz PPDU may be configured based on the following equation. The example shown below may be a first type (i.e., 1× STF) sequence.

EHT-STF(−240:16:240)={M, 0, −M}*(1+j)/sqrt(2) <Equation 3>

An EHT-STF for an 80 MHz PPDU may be configured based on the following equation. The example shown below may be a first type (i.e., 1× STF) sequence.

EHT-STF(−496:16:496)={M, 1, −M, 0, −M, 1, −M}*(1+j)/sqrt(2) <Equation 4>

An EHT-STF for a 160 MHz PPDU may be configured based on the following equation. The example shown below may be a first type (i.e., 1× STF) sequence.

EHT-STF(−1008:16:1008)={M, 1, −M, 0, −M, 1, −M, 0, −M, −1, M, 0, −M, 1, −M}*(1+j)/sqrt(2) <Equation 5>

In the EHT-STF for an 80+80 MHz PPDU, a sequence for a lower 80 MHz may be the same as Equation 4. And, in the EHT-STF for the 80+80 MHz PPDU, a sequence for a higher 80 MHz may be configured based on the following equation.

EHT-STF(−496:16:496)={−M, −1, M, 0, −M, 1, −M}*(1+j)/sqrt(2) <Equation 6>

Hereinafter, Equation 7 to Equation 11 relate to examples of a second type (i.e., 2× STF) sequence.

EHT-STF(−120:8:120)={M, 0, −M}*(1+j)/sqrt(2) <Equation 7>

An EHT-STF for a 40 MHz PPDU may be configured based on the following equation.

EHT-STF(−248:8:248)={M, −1, −M, 0, M, −1, M}*(1+j)/sqrt(2)

EHT-STF(−248)=0

EHT-STF(248)=0 <Equation 8>

An EHT-STF for an 80 MHz PPDU may be configured based on the following equation.

EHT-STF(−504:8:504)={M, −1, M, −1, −M, −1, M, 0, −M, 1, M, 1, −M, 1, −M}*(1+j)/sqrt(2) <Equation 9>

An EHT-STF for a 160 MHz PPDU may be configured based on the following equation.

EHT-STF(−1016:16:1016)={M, −1, M, −1, −M, −1, M, 0, −M, 1, M, 1, −M, 1, −M, 0, −M, 1, −M, 1, M, 1, −M, 0, −M, 1, M, 1, −M, 1, −M}*(1+j)/sqrt(2)

EHT-STF(−8)=0, EHT-STF(8)=0,

EHT-STF(−1016)=0, EHT-STF(1016)=0 <Equation 10>

In the EHT-STF for an 80+80 MHz PPDU, a sequence for a lower 80 MHz may be the same as Equation 9. And, in the EHT-STF for the 80+80 MHz PPDU, a sequence for a higher 80 MHz may be configured based on the following equation.

EHT-STF(−504:8:504)={−M, 1, −M, 1, M, 1, −M, 0, −M, 1, M, 1, −M, 1, −M}*(1+j)/sqrt(2)

EHT-STF(−504)=0,

EHT-STF(504)=0 <Equation 11>

An EHT-LTF may have first, second, and third types (i.e., 1×, 2×, 4× LTF). For example, the first/second/third type LTF may be generated based on an LTF sequence in which non-zero coefficients are positioned at 4/2/1 subcarrier spacing(s). The first/second/third type LTF may have a time length of 3.2/6.4/12.8 μs. Additionally, various lengths of GI (e.g., 0.8/1/6/3.2 μs) may be applied to the first/second/third type LTF.

Information related to an STF and/or LTF type (including information related to GI that is applied to the LTF) may be included in an SIG A field and/or SIG B field of FIG. 18.

The PPDU (i.e., EHT-PPDU) of FIG. 18 may be configured based on examples of FIG. 5 and FIG. 6.

For example, an EHT PPDU being transmitted over a 20 MHz band, i.e., a 20 MHz EHT PPDU, may be configured based on RUs of FIG. 5. That is, the location of an RU of the EHT-STF, EHT-LTF, data field being included in the EHT PPDU may be determined as shown in FIG. 5.

An EHT PPDU being transmitted over a 40 MHz band, i.e., a 40 MHz EHT PPDU, may be configured based on RUs of FIG. 6. That is, the location of an RU of the EHT-STF, EHT-LTF, data field being included in the EHT PPDU may be determined as shown in FIG. 6.

Since the RU location of FIG. 6 corresponds to 40 MHz, if the pattern of FIG. 6 is repeated two times, a tone plan for 80 MHz may be determined. That is, an 80 MHz EHT PPDU may be transmitted based on a new tone plan in which the RU of FIG. 6 is repeated two times, and not the RU of FIG. 7.

In case the pattern of FIG. 6 is repeated two times, 23 tones (i.e., 11 guard tones+12 guard tones) may be configured in a DC region. That is, a tone plan for an 80 MHz EHT PPDU being allocated based on OFDMA may have 23 DC tones. On the other hand, an 80 MHz EHT PPDU being allocated based on non-OFDMA (i.e., non-OFDMA full Bandwidth 80 MHz PPDU) may be configured based on 996 RUs and may include 5 DC tones, 12 left-guard tones, and 11 right-guard tones.

A tone plan for 160/240/320 MHz may be configured to have a format of repeating the pattern of FIG. 6 multiple times.

The PPDU of FIG. 18 may be determined (or identified) as an EHT PPDU based on the following method.

A Receiving STA may determine a type of an RX PPDU as the EHT PPDU, based on the following aspect. For example, the RX PPDU may be determined as the EHT PPDU: 1) when a first symbol after an L-LTF signal of the RX PPDU is a BPSK symbol; 2) when RL-SIG in which the L-SIG of the RX PPDU is repeated is detected; and 3) when a result of applying “module 3” to a value of a length field of the L-SIG of the RX PPDU is detected as “0”. When the RX PPDU is determined as the EHT PPDU, the Receiving STA may detect a type of the EHT PPDU (e.g., an SU/MU/Trigger-based/Extended Range type), based on bit information included in a symbol after the RL-SIG of FIG. 18. In other words, the Receiving STA may determine the RX PPDU as the EHT PPDU, based on: 1) a first symbol after an L-LTF signal, which is a BPSK symbol; 2) RL-SIG contiguous to the L-SIG field and identical to L-SIG; 3) L-SIG including a length field in which a result of applying “modulo 3” is set to “0”; and 4) a 3-bit PHY version identifier of the aforementioned U-SIG (e.g., a PHY version identifier having a first value).

For example, the Receiving STA may determine the type of the RX PPDU as the EHT PPDU, based on the following aspect. For example, the RX PPDU may be determined as the HE PPDU: 1) when a first symbol after an L-LTF signal is a BPSK symbol; 2) when RL-SIG in which the L-SIG is repeated is detected; and 3) when a result of applying “module 3” to a value of a length field of the L-SIG is detected as “1” or “2”.

For example, the Receiving STA may determine the type of the RX PPDU as a non-HT, HT, and VHT PPDU, based on the following aspect. For example, the RX PPDU may be determined as the non-HT, HT, and VHT PPDU: 1) when a first symbol after an L-LTF signal is a BPSK symbol; and 2) when RL-SIG in which L-SIG is repeated is not detected. In addition, even if the Receiving STA detects that the RL-SIG is repeated, when a result of applying “modulo 3” to the length value of the L-SIG is detected as “0”, the RX PPDU may be determined as the non-HT, HT, and VHT PPDU.

In the following example, a signal represented as a (TX/RX/UL/DL) signal, a (TX/RX/UL/DL) frame, a (TX/RX/UL/DL) packet, a (TX/RX/UL/DL) data unit, (TX/RX/UL/DL) data, or the like may be a signal transmitted/received based on the PPDU of FIG. 18. The PPDU of FIG. 18 may be used to transmit/receive frames of various types. For example, the PPDU of FIG. 18 may be used for a control frame. An example of the control frame may include a request to send (RTS), a clear to send (CTS), a power save-poll (PS-poll), BlockACKReq, BlockAck, a null data packet (NDP) announcement, and a trigger frame. For example, the PPDU of FIG. 18 may be used for a management frame. An example of the management frame may include a beacon frame, a (re-)association request frame, a (re-)association response frame, a probe request frame, and a probe response frame. For example, the PPDU of FIG. 18 may be used for a data frame. For example, the PPDU of FIG. 18 may be used to simultaneously transmit at least two or more of the control frame, the management frame, and the data frame.

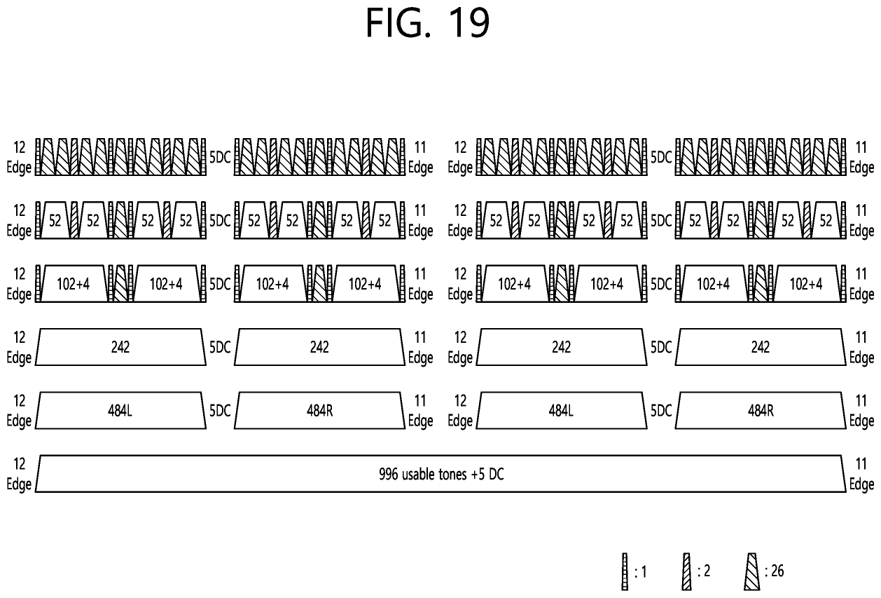

FIG. 19 illustrates a tone plan for an 80 MHz band in an EHT WLAN system.

As described above, in the EHT wireless LAN system, the tone plan for the 80 MHz band may be defined by repeating twice the tone plan of 40 MHz (the RU pattern in FIG. 6) defined in the 802.11ax wireless LAN system. FIG. 19 is a diagram illustrating a tone plan for an 80 MHz band of an EHT wireless LAN system as a specific RU pattern.

Referring to FIG. 19, a tone-plan for an 80 MHz EHT PPDU allocated based on OFDMA may have 23 DC tones (ie, 11 guard tones+12 guard tones). Also, one or two null tones (or null subcarriers) may be inserted between 26 RU, 52 RU, and 106 RU (shown as 102+4 RU). FIG. 19 illustrates the position and number of null subcarriers shown in FIG. 6 in more detail.

In addition, both the left 484 RU and the right 484 RU shown in FIG. 19 may include 5 DC tones in the center. In the left 484 RU, the RU on the left of the DC tone in the center is indicated by 484 L, and the RU on the right is indicated by 484 R. Similarly, in the right 484 RU, the RU to the left of the central DC tone is indicated by 484 L, and the RU to the right is indicated by 484 R.

In contrast, the 80 MHz EHT PPDU (i.e., non-OFDMA full bandwidth 80 MHz PPDU) allocated based on Non-OFDMA may be configured based on 996 RUs and may include 5 DC tones, 12 left guard tones, and 11 right guard tones.

In the EHT wireless LAN system, the tone-plan for 160/240/320 MHz may be configured in the form of repeating the pattern of FIG. 19 several times.

1. Tone Plan in 802.11ax WLAN System

In this specification, a tone plan relates to a rule for determining a size of a resource unit (RU) and/or a location of the RU. Hereinafter, a PPDU based on the IEEE 802.11ax standard, that is, a tone plan applied to an HE PPDU, will be described. In other words, hereinafter, the RU size and RU location applied to the HE PPDU are described, and control information related to the RU applied to the HE PPDU is described.

In this specification, control information related to an RU (or control information related to a tone plan) may include a size and location of the RU, information of a user STA allocated to a specific RU, a frequency bandwidth for a PPDU in which the RU is included, and/or control information on a modulation scheme applied to the specific RU. The control information related to the RU may be included in an SIG field. For example, in the IEEE 802.11ax standard, the control information related to the RU is included in an HE-SIG-B field. That is, in a process of generating a TX PPDU, a transmitting STA may allow the control information on the RU included in the PPDU to be included in the HE-SIG-B field. In addition, a Receiving STA may receive an HE-SIG-B included in an RX PPDU and obtain control information included in the HE-SIG-B, so as to determine whether there is an RU allocated to the Receiving STA and decode the allocated RU, based on the HE-SIG-B.

In the IEEE 802.11ax standard, HE-STF, HE-LTF, and data fields may be configured in unit of RUs. That is, when a first RU for a first Receiving STA is configured, STF/LTF/data fields for the first Receiving STA may be transmitted/received through the first RU.

In the IEEE 802.11ax standard, a PPDU (i.e., SU PPDU) for one Receiving STA and a PPDU (i.e., MU PPDU) for a plurality of Receiving STAs are separately defined, and respective tone plans are separately defined. Specific details will be described below.

The RU defined in 11ax may include a plurality of subcarriers. For example, when the RU includes N subcarriers, it may be expressed by an N-tone RU or N RUs. A location of a specific RU may be expressed by a subcarrier index. The subcarrier index may be defined in unit of a subcarrier frequency spacing. In the 11ax standard, the subcarrier frequency spacing is 312.5 kHz or 78.125 kHz, and the subcarrier frequency spacing for the RU is 78.125 kHz. That is, a subcarrier index +1 for the RU may mean a location which is more increased by 78.125 kHz than a DC tone, and a subcarrier index −1 for the RU may mean a location which is more decreased by 78.125 kHz than the DC tone. For example, when the location of the specific RU is expressed by [−121:−96], the RU may be located in a region from a subcarrier index −121 to a subcarrier index −96. As a result, the RU may include 26 subcarriers.

The N-tone RU may include a pre-set pilot tone.

2. Null Subcarrier and Pilot Subcarrier

A subcarrier and resource allocation in the 802.11ax system will be described.

An OFDM symbol consists of subcarriers, and the number of subcarriers may function as a bandwidth of a PPDU. In the WLAN 802.11 system, a data subcarrier used for data transmission, a pilot subcarrier used for phase information and parameter tacking, and an unused subcarrier not used for data transmission and pilot transmission are defined.

An HE MU PPDU which uses OFDMA transmission may be transmitted by mixing a 26-tone RU, a 52-tone RU, a 106-tone RU, a 242-tone RU, a 484-tone RU, and a 996-tone RU.

Herein, the 26-tone RU consists of 24 data subcarriers and 2 pilot subcarriers. The 52-tone RU consists of 48 data subcarriers and 4 pilot subcarriers. The 106-tone RU consists of 102 data subcarriers and 4 pilot subcarriers. The 242-tone RU consists of 234 data subcarriers and 8 pilot subcarriers. The 484-tone RU consists of 468 data subcarriers and 16 pilot subcarriers. The 996-tone RU consists of 980 data subcarriers and 16 pilot subcarriers.

1) Null Subcarrier

As shown in FIG. 5 to FIG. 7, a null subcarrier exists between 26-tone RU, 52-tone RU, and 106-tone RU locations. The null subcarrier is located near a DC or edge tone to protect against transmit center frequency leakage, receiver DC offset, and interference from an adjacent RU. The null subcarrier has zero energy. An index of the null subcarrier is listed as follows.

| Channel | | |
|---|---|---|
| Width | RU Size | Null Subcarrier Indices |
| 20 MHz | 26, 52 | ±69, ±122 |
| | 106 | none |
| | 242 | none |
| 40 MHz | 26, 52 | ±3, ±56, ±57, ±110, ±137, ±190, |
| | | ±191, ±244 |
| | 106 | ±3, ±110, ±137, ±244 |
| | 242, 484 | none |
| 80 MHz | 26, 52 | ±17, ±70, ±71, ±124, ±151, ±204, |
| | | ±205, ±258, ±259, ±312, ±313, ±366, |
| | | ±393, ±446, ±447, ±500 |
| | 106 | ±17, ±124, ±151, ±258, ±259, ±366, |
| | | ±393, ±500 |
| | 242, 484 | none |
| | 996 | none |
| 160 MHz | 26, 52, 106 | {null subcarrier indices in 80 MHz − |
| | | 512, null subcarrier indices in 80 MHz + |
| | | 512} |
| | 242, 484, 996, | none |
| | 2 × 996 | |

A null subcarrier location for each 80 MHz frequency segment of the 80+80 MHz HE PPDU shall follow the location of the 80 MHz HE PPDU.

2) Pilot Subcarrier

If a pilot subcarrier exists in an HE-LTF field of HE SU PPDU, HE MU PPDU, HE ER SU PPDU, or HE TB PPDU, a location of a pilot sequence in an HE-LTF field and data field may be the same as a location of 4× HE-LTF. In 1× HE-LTF, the location of the pilot sequence in HE-LTF is configured based on pilot subcarriers for a data field multiplied 4 times. If the pilot subcarrier exists in 2× HE-LTF, the location of the pilot subcarrier shall be the same as a location of a pilot in a 4× data symbol. All pilot subcarriers are located at even-numbered indices listed below.

| Channel | | |
|---|---|---|
| Width | RU Size | Pilot Subcarrier Indices |
| 20 MHz | 26, 52 | ±10, ±22, ±36, ±48, ±62, ±76, |
| | | ±90, ±102, ±116 |
| | 106, 242 | ±22, ±48, ±90, ±116 |
| 40 MHz | 26, 52 | ±10, ±24, ±36, ±50, ±64, ±78, |
| | | ±90, ±104, ±116, ±130, ±144, ±158, |
| | | ±170, ±184, ±198, ±212, ±224, ±238 |
| | 106, 242, 484 | ±10, ±36, ±78, ±104, ±144, ±170, |
| | | ±212, ±238 |
| 80 MHz | 26, 52 | ±10, ±24, ±38, ±50, ±64, ±78, |
| | | ±92, ±104, ±118, ±130, ±144, ±158, |
| | | ±172, ±184, ±198, ±212, ±226, ±238, |
| | | ±252, ±266, ±280, ±292, ±306, ±320, |
| | | ±334, ±346, ±360, ±372, ±386, ±400, |
| | | ±414, ±426, ±440, ±454, ±468, ±480, |
| | | ±494 |
| | 106, 242, 484 | ±24, ±50, ±92, ±118, ±158, ±184, |
| | | ±226, ±252, ±266, ±292, ±334, ±360, |
| | | ±400, ±426, ±468, ±494 |
| | 996 | ±24, ±92, ±158, ±226, ±266, ±334, |
| | | ±400, ±468 |
| 160 MHz | 26, 52, 106, | {pilot subcarrier indices in 80 MHz − |
| | 242, 484 | 512, pilot subcarrier indices in 80 MHz + |
| | | 512} |
| | 996 | {for the lower 80 MHz, pilot subcarrier |
| | | indices in 80 MHz − 512, for the upper 80 |
| | | MHz, pilot subcarrier indices in 80 MHz + |
| | | 512} |

At 160 MHz or 80+80 MHz, the location of the pilot subcarrier shall use the same 80 MHz location for 80 MHz of both sides.

3. Embodiment which may be Applied to the Present Disclosure

In the WLAN 802.11 system, the increased transmission of a system is considered by using a wider band than the existing 11ax or more antennas in order to increase peak throughput. Furthermore, in the present disclosure, a method using aggregating and using various bands is also considered.

In the present disclosure, a case where a wide band is used is considered. In particular, there is proposed a method of configuring a tone plan having a 240 MHz bandwidth by applying puncturing to the tone plan of the 240 MHz bandwidth in a tone plan of a 320 MHz bandwidth.

Technical characteristics of tone plans described hereinafter and indicator information therefor may use technical characteristics in 802.11ax without any change. For example, characteristics of RU allocation information may be identically applied to an RU in the 802.11be/EHT standards. That is, the characteristics of RU allocation information may also be identically applied to an RU included in an STF/LTF/data field within an EHT PPDU. Furthermore, a location and the size of an RU included in a specific frequency band, a pilot signal within the RU, and a location of a null subcarrier disposed between RUs may also be identically applied to an EHT PPDU described hereinafter.

3.1. Repetition of 80 MHz Tone Plan

A tone plan having 320 MHz may be composed of a method of repeating four 80 MHz tone plans (refer to FIG. 7) of the existing 802.11ax or four 80 MHz tone plans (refer to FIG. 19) that are newly proposed. The tone plan having 320 MHz may be applied to both contiguous/non-contiguous situations. In such a case, 80 MHz may be applied to the same tone plan.

A specific busy 80 MHz channel in a 320 MHz channel may be punctured, and a 240 MHz bandwidth may be transmitted therein. In this case, the aforementioned 80 MHz tone plan repetition may be applied to a 240 MHz tone plan regardless of contiguous/non-contiguous situations.

3.2. New Tone Plan

For an OFDMA tone plan, the tone plan proposed in 3.1 may be used. However, in the case of SU or in a situation in which a full bandwidth is used for MU MIMO transmission, the following new tone plan (new RU) may be defined in order to improve throughput.

A. Repetition of New Two 160 MHz Tone Plans

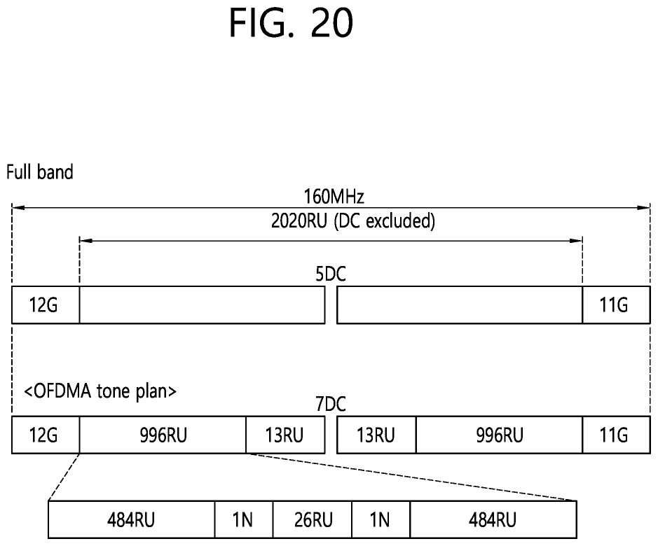

FIG. 20 illustrates an example of a tone plan for a 160 MHz band, which is proposed in the present embodiment.

FIG. 20 illustrates both a tone plan in the case of a full band and a tone plan if OFDMA is applied.

First, in the case of the full band, a tone plan for 160 MHz may consist of 12 guard tones, 2020 RUs, 5 DC tones, and 11 guard tones it their order. The 5 DC tones may be disposed in the middle of the 160 MHz, and data may be transmitted in the 2020 RUs. However, FIG. 20 is merely an embodiment. The locations of the 12 guard tones and the 11 guard tones may be changed. If 7 DC tones are disposed in the middle of the 160 MHz, data may be transmitted in a 2018 RU.

If OFDMA is applied, a tone plan for 160 MHz may consist of 12 guard tones, 996 RUs, a 13 RU, 7 DC tones, 13 RUs, 996 RUs and 11 guard tones in their order. Furthermore, the 996 RUs may consist of 484 RUs, 1 null tone, 26 RUs, 1 null tone and 484 RUs. However, FIG. 20 is merely an embodiment. The locations of the 12 guard tones and the 11 guard tones may be changed, and the 996 RUs may consist of 1 null tone, 484 RUs, 26 RUs, 484 RUs and 1 null tone.

The tone plan may have the same structure as the existing 11ax from the 484 RU, and thus is not illustrated.

A 320 MHz bandwidth may consist of only bandwidths of non-contiguous 160+160 MHz and contiguous 320 MHz in order to reduce hardware complexity. In this case, the same tone plan is maintained in the contiguous and non-contiguous situations, but a new 160 MHz tone plan for maximizing throughput may be used. FIG. 20 is an example of a 160 MHz new tone plan.

<12 Left Guard Tones, 11 Right Guard Tones, 5 DC, a 2020 Tone RU>

In this case, if specific 80 MHz of 320 MHz is punctured, a tone plan for 240 MHz is proposed as follows. 80 MHz channels of the 320 MHz may be divided in a frequency region.

1) If an 80 MHz Channel having the Lowest Frequency is Punctured

i) If 12 left guard tones, 11 right guard tones, 5 DC, a 2020 tone RU have been used in two 160 MHz channels in 320 MHz, only 3 tones (3 tones of the 5 DC tones) have been nulled in a left guard part of the second lowest frequency 80 MHz channel. Since leakage may occur due to an adjacent channel, some tones may be additionally nulled and configured. For example, a total of 12 left guard tones may be configured. A tone plan applied to 320 MHz may be applied to the remaining not-punctured part without any change.

ii) Alternatively, the 12 left guard tones are configured and a DC tone may also be added to the middle of the second lowest frequency 80 MHz channel. For example, 5 DC tones may be configured. A tone plan applied to 320 MHz may be used for the remaining not-punctured 80 MHz channel without any change.

iii) Alternatively, a tone plan for the second lowest frequency 80 MHz channel may be simply substituted with the existing 11ax 80 MHz tone plan. That is, a 996 tone RU may be used. A tone plan applied to 320 MHz may be used for the remaining not-punctured 80 MHz channel without any change.

2) If an 80 MHz Channel having the Second Lowest Frequency is Punctured

i) If 12 left guard tones, 11 right guard tones, 5 DC, a 2020 tone RU have been used in two 160 MHz channels in 320 MHz, only 2 tones (2 tones of the 5 DC tones) are nulled in a right guard part of the lowest frequency 80 MHz channel. Since leakage may occur due to an adjacent channel, some tones may be additionally nulled and configured. For example, a total of 11 right guard tones may be configured. A tone plan applied to 320 MHz may be applied to the remaining not-punctured part without any change.

ii) Alternatively, 11 right guard tones are configured, and a DC tone may also be added to the middle of the lowest frequency 80 MHz channel. For example, 5 DC tones may be configured. A tone plan applied to 320 MHz may be used for the remaining not-punctured 80 MHz channel without any change.

iii) Alternatively, a tone plan for the lowest frequency 80 MHz channel may be simply substituted with the existing 11ax 80 MHz tone plan. That is, a 996 tone RU may be used. A tone plan applied to 320 MHz may be used for the remaining not-punctured 80 MHz channel without any change.

3) If an 80 MHz Channel for the Third Lowest Frequency is Punctured

i) If 12 left guard tones, 11 right guard tones, 5 DC, and a 2020 tone RU have been used in two 160 MHz channels in 320 MHz, only 3 tones (3 tones of the 5 DC tones) are nulled in a left guard part of the highest frequency 80 MHz channel. Since leakage may occur due to an adjacent channel, some tones may be additionally nulled and configured. For example, a total of 12 left guard tones may be configured. A tone plan applied to 320 MHz may be applied to the remaining not-punctured part without any change.

ii) Alternatively, 12 left guard tones are configured, and a DC tone may also be added to the middle of the highest frequency 80 MHz channel. For example, 5 DC tones may be configured. A tone plan applied to 320 MHz may be used for the remaining not-punctured 80 MHz channel without any change.

iii) Alternatively, a tone plan for the highest frequency 80 MHz channel may be simply substituted with the existing 11ax 80 MHz tone plan. That is, a 996 tone RU may be used. A tone plan applied to 320 MHz may be used for the remaining not-punctured 80 MHz channel without any change.

4) If an 80 MHz Channel having the Highest Frequency is Punctured

i) If 12 left guard tones, 11 right guard tones, 5 DC, and a 2020 tone RU have been used in two 160 MHz channels in 320 MHz, only 2 tones (2 tones of the 5 DC tones) are nulled in a right guard part of the third lowest frequency 80 MHz channel. Since leakage may occur due to an adjacent channel, some tones may be additionally nulled and configured. For example, a total of 11 right guard tones may be configured. A tone plan applied to 320 MHz may be applied to the remaining not-punctured part without any change.

ii) Alternatively, 11 right guard tones are configured, and a DC tone may also be added to the middle of the third lowest frequency 80 MHz channel. For example, 5 DC tones may be configured. A tone plan applied to 320 MHz may be used for the remaining not-punctured 80 MHz channel without any change.

iii) Alternatively, a tone plan for the third lowest frequency 80 MHz channel may be simply substituted with the existing 11ax 80 MHz tone plan. That is, a 996 tone RU may be used. A tone plan applied to 320 MHz may be used for the remaining not-punctured 80 MHz channel without any change.

Alternatively, a 240 MHz tone plan may be configured by repeating the existing 80 MHz tone plan as proposed in 3.1 regardless of the 320 MHz tone plan.

B. New 320 MHz Tone Plan

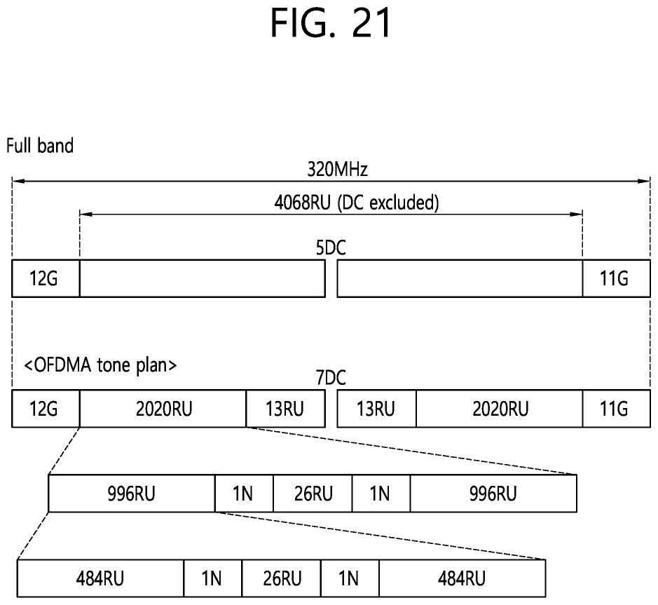

FIG. 21 illustrates an example of a tone plan for a 320 MHz band, which is proposed in the present embodiment.

FIG. 21 illustrates both tone planes in the case of a full band and if OFDMA is applied.

First, in the case of the full band, a tone plan for 320 MHz may consist of 12 guard tones, 4068 RUs, 5 DC tones, and 11 guard tones in their order. 5 DC tones may be disposed in the middle of the 320 MHz, and data may be transmitted in the 4068 RUs. However, FIG. 21 is merely an embodiment. The locations of the 12 guard tones and the 11 guard tones may be changed. If 7 DC tones are disposed in the middle of the 320 MHz, data may be transmitted in 4066 RUs.

If OFDMA is applied, a tone plan for 320 MHz may consist of 12 guard tones, 2020 RUs, 13 RUs, 7 DC tones, 13 RUs, 2020 RUs and 11 guard tones in their order. Furthermore, the 2020 tone RU may consist of 996 RUs, 1 null tone, 26 RUs, a 1 null tone and 996 RUs. Furthermore, the 996 RU may consist of 484 RUs, 1 null tone, 26 RUs, 1 null tone and 484 RUs. However, FIG. 21 is merely an embodiment. The locations of the 12 guard tones and the 11 guard tones may be changed. The 996 RUs may consist of 1 null tone, 484 RUs, 26 RUs, 484 RUs and 1 null tone.

The tone plan may have the same structure as the existing 11ax from the 484 RUs, and thus it is not illustrated.

In contiguous 320 MHz, a new RU may be defined in order to maximize throughput, and FIG. 21 is an example thereof.

<12 Left Guard Tones, 11 Right Guard Tones, 5 DC, a 4068 Tone RU>

In this case, if specific 80 MHz of 320 MHz is punctured, a tone plan for 240 MHz is proposed as follows.

1) If an 80 MHz Channel having the Lowest Frequency is Punctured

i) If 12 left guard tones, 11 right guard tones, 5 DC, a 4068 tone RU have been used in 320 MHz, there is no nulled tone in a left guard part of the second lowest frequency 80 MHz channel. Since leakage may occur due to an adjacent channel, some tones may be additionally nulled and configured. For example, a total of 12 left guard tones may be configured. A tone plan applied to 320 MHz may be used for the remaining not-punctured 80 MHz channel without any change.

ii) Alternatively, a tone plan for the second lowest frequency 80 MHz channel may be simply substituted with the existing 11ax 80 MHz tone plan. That is, a 996 tone RU may be used. Furthermore, the aforementioned new 160 MHz tone plan (refer to FIG. 20) of 3.2. A may be used for a tone plan for the remaining 160 MHz channel (the third lowest frequency 80 MHz channel and the highest frequency 80 MHz channel).

2) If an 80 MHz Channel having the Second Lowest Frequency is Punctured

i) If 12 left guard tones, 11 right guard tones, 5 DC, a 4068 tone RU have been used in 320 MHz, there is no nulled tone a right guard part of the lowest frequency 80 MHz channel. Since leakage may occur due to an adjacent channel, some tones may be additionally nulled and configured. For example, a total of 11 right guard tones may be configured. Furthermore, only 3 tones (3 tones of the 5 DC tones) are nulled in a left guard part of the third lowest frequency 80 MHz channel. Since leakage may occur due to an adjacent channel, some tones may be additionally nulled and configured. For example, a total of 12 left guard tones may be configured. A tone plan applied to 320 MHz may be applied to the remaining not-punctured part without any change.

ii) Alternatively, 11 right guard tones may be configured in the lowest frequency 80 MHz channel and a DC tone may be added in the middle of the corresponding 80 MHz channel, and 12 left guard tones may be configured in the third lowest frequency 80 MHz channel and a DC tone may also be added to the middle of a 160 MHz channel (the third lowest frequency 80 MHz channel and the highest frequency 80 MHz channel). For example, 5 DC tones may be configured. A tone plan applied to 320 MHz may be applied to the remaining not-punctured part without any change.

iii) Alternatively, a tone plan for the lowest frequency 80 MHz channel may be simply substituted with the existing 11ax 80 MHz tone plan. That is, a 996 tone RU may be used. Furthermore, the new 160 MHz tone plan of 3.2. A may be used for a tone plan for the remaining 160 MHz channel (the third lowest frequency 80 MHz channel and the highest frequency 80 MHz channel).

3) If an 80 MHz Channel for the Third Lowest Frequency is Punctured

i) If 12 left guard tones, 11 right guard tones, 5 DC, a 4068 tone RU have been used in 320 MHz, there is no nulled tone in a left guard part of the highest frequency 80 MHz channel. Since leakage may occur due to an adjacent channel, some tones may be additionally nulled and configured. For example, a total of 12 left guard tones may be configured. Furthermore, only 2 tones (2 tones of the 5 DC tones) are nulled in a right guard part of the second lowest frequency 80 MHz channel. Since leakage may occur due to an adjacent channel, some tones may be additionally nulled and configured. For example, a total of 11 right guard tones may be configured. A tone plan applied to 320 MHz may be applied to the remaining not-punctured part without any change.

ii) Alternatively, 12 left guard tones may be configured in the highest frequency 80 MHz channel and a DC tone may be added to the middle of the corresponding 80 MHz channel, and 11 right guard tones may be configured in the second lowest frequency 80 MHz channel and a DC tone may also be added to the middle of a 160 MHz channel (the lowest frequency 80 MHz channel and the second lowest frequency 80 MHz channel). For example, 5 DC tones may be configured. A tone plan applied to 320 MHz may be applied to the remaining not-punctured part without any change.

iii) Alternatively, the highest frequency 80 MHz channel [symbol] tone plan may be simply substituted with the existing 11ax 80 MHz tone plan. That is, a 996 tone RU may be used. Furthermore, the new 160 MHz tone plan of 3.2. A may be used for a tone plan for the remaining 160 MHz channel (the lowest frequency 80 MHz channel and the second lowest frequency 80 MHz channel).

4) If an 80 MHz Channel having the Highest Frequency is Punctured

i) If 12 left guard tones, 11 right guard tones, 5 DC, a 4068 tone RU have been used in 320 MHz, there is no nulled tone in a right guard part of the third lowest frequency 80 MHz channel. Since leakage may occur due to an adjacent channel, some tones may be additionally nulled and configured. For example, a total of 11 right guard tones may be configured. A tone plan applied to 320 MHz may be used for the remaining not-punctured 80 MHz channel without any change.

ii) Alternatively, a tone plan for the third lowest frequency 80 MHz channel may be simply substituted with the existing 11ax 80 MHz tone plan. That is, a 996 tone RU may be used. Furthermore, the new 160 MHz tone plan of 3.2. A may be used for a tone plan for the remaining 160 MHz channel (the lowest frequency 80 MHz channel and the second lowest frequency 80 MHz channel).

Alternatively, a 240 MHz tone plan may be configured by repeating the existing 80 MHz tone plan as proposed in 3.1 regardless of the 320 MHz tone plan.

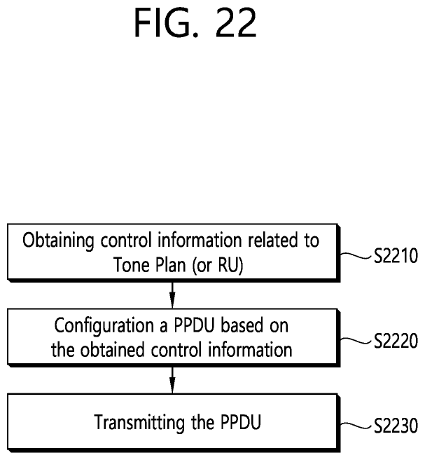

FIG. 22 is a procedure flowchart illustrating an operation of a transmission apparatus according to the present embodiment.

An example of FIG. 22 may be performed in a transmission apparatus (AP and/or non-AP STA). Some of steps (or detailed sub-steps to be described later) of the example of FIG. 22 may be omitted or changed.

In step S2210, a transmission apparatus (transmitting STA) may obtain information about the aforementioned tone plan. As described above, the information about the tone plan includes the size and location of an RU, control information related to the RU, information about a frequency band including the RU, information about an STA that receives the RU, etc.

In step S2220, the transmission apparatus may configure/generate a PPDU based on the obtained control information. The step of configuring/generating the PPDU may include a step of configuring/generating each field of the PPDU. That is, step S2220 includes a step of configuring an EHT-SIG-A/B/C field including control information about a tone plan. That is, step S2220 may include a step of configuring a field including control information (e.g., N bitmap) indicative of the size/location of an RU and/or a step of configuring a field including the identifier (e.g., AID) of an STA that receives the RU.

Furthermore, step S2220 may include a step of generating an STF/LTF sequence transmitted through a specific RU. The STF/LTF sequence may be generated based on a pre-configured STF generation sequence/LTF generation sequence.

Furthermore, step S2220 may include a step of generating a data field (i.e., MPDU) transmitted through a specific RU.

In step S2230, the transmission apparatus may transmit, to a reception apparatus, the PPDU configured through step S2220 based on step S2230.

While performing step S2230, the transmission apparatus may perform at least one of operations, such as CSD, spatial mapping, an IDFT/IFFT operation, and GI insert.

The signal/field/sequence configured according to the present disclosure may be transmitted in the form of FIG. 19.

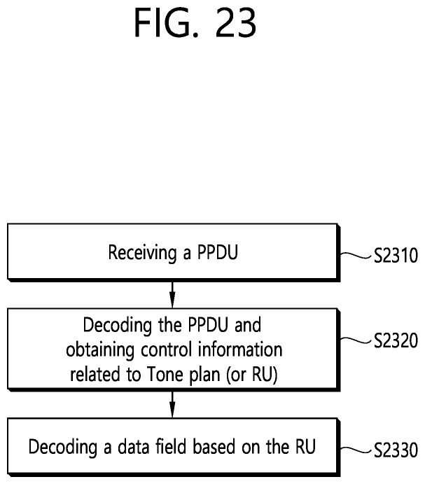

FIG. 23 is a procedure flowchart illustrating an operation of a reception apparatus according to the present embodiment.

An example of FIG. 23 may be performed in the reception apparatus (AP and/or non-AP STA).

Some of steps (or detailed sub-steps to be described later) of the example of FIG. 23 may be omitted.

In step S2310, the reception apparatus (Receiving STA) may receive some of or the entire PPDU through step S2210. The received signal may have the form of FIG. 19.

A sub-step of step S2310 may be determined based on step S2230. That is, in step S2310, an operation of restoring the results of CSD, spatial mapping, an IDFT/IFFT operation, and a GI insert operation applied in step S2230, may be performed.

In step S2320, the reception apparatus may perform decoding on the entire or some of the PPDU. Furthermore, the reception apparatus may obtain control information related to a tone plan (i.e., RU) from the decoded PPDU.

More specifically, the reception apparatus may decode an L-SIG and EHT-SIG of the PPDU based on a legacy STF/LTF, and may obtain information included in the L-SIG and EHT SIG fields. Information about various tone plans (i.e., RUs) described in the present disclosure may be included in the EHT-SIG (EHT-SIG-A/B/C, etc.). The Receiving STA may obtain information about a tone plan (i.e., RU) through EHT-SIG.

In step S2330, the reception apparatus may decode the remaining part of the PPDU based on the information about a tone plan (i.e., RU), which is obtained through step S2320. For example, the Receiving STA may decode the STF/LTF field of the PPDU based on the information about one plan (i.e., RU). Furthermore, the Receiving STA may decode the data field of the PPDU based on the information about a tone plan (i.e., RU), and may obtain an MPDU included in the data field.

Furthermore, the reception apparatus may perform a processing operation of delivering, to a higher layer (e.g., MAC layer), the data decoded through step S2330. Furthermore, if the generation of a signal from the higher layer to the PHY layer is indicated in accordance with the data delivered to the higher layer, the reception apparatus may perform a subsequent operation.

Hereinafter, the aforementioned embodiment is described with reference to FIGS. 1 to 23.

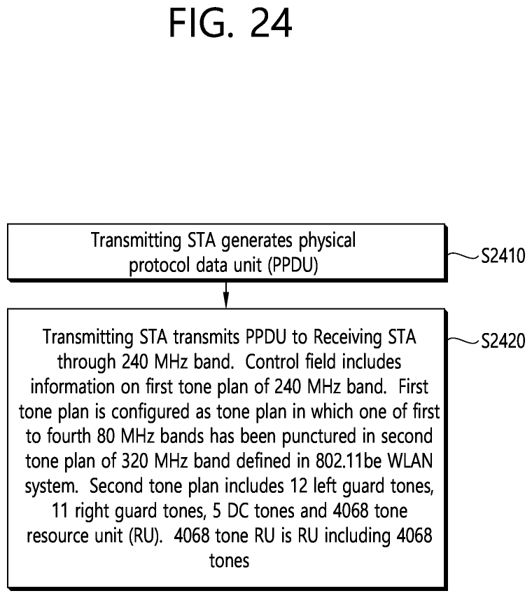

FIG. 24 is a flowchart illustrating a procedure of transmitting, by a transmitting STA, a PPDU in a wideband according to the present embodiment.

An example of FIG. 24 may be performed in a network environment in which a next-generation WLAN system (IEEE 802.11be or EHT WLAN system) is supported. The next-generation WLAN system may satisfy backward compatibility with an 802.11ax system as a WLAN system improved from the 802.11ax system.

The example of FIG. 24 may be performed in a transmitting STA, and the transmitting STA may correspond to an access point (AP). A Receiving STA in FIG. 24 may correspond to an STA supporting an extremely high throughput (EHT) WLAN system.

The present embodiment proposes a method of configuring a tone plan for transmitting a PPDU in widebands (240 MHz and 320 MHz band) supported in an EHT WLAN system. In particular, the present embodiment proposes a method of configuring a tone plan having a 240 MHz band by performing 80 MHz puncturing on a tone plan of a 320 MHz band and transmitting and receiving PPDUs.

In step S2410, the transmitting Station (STA) generates a physical protocol data unit (PPDU).

In step S2420, the transmitting STA transmits the PPDU to the Receiving STA through a 240 MHz band.

The PPDU includes a control field and a data field.

The control field includes information on a first tone plan having a 240 MHz band. The first tone plan is configured as a tone plan in which one of first to fourth 80 MHz bands has been punctured in a second tone plan of a 320 MHz band defined in the 802.11be WLAN system. The first tone plan may be used in order to transmit the PPDU regardless of whether the 240 MHz band is continuous or non-continuous.

The second tone plan may be a tone plan of the 320 MHz band, which has been newly defined in the 802.11be WLAN system, or may be a tone plan obtained by twice repeating a tone plan of a 160 MHz band, which has been newly defined in the 802.11be WLAN system. The second tone plan has been defined for throughput improvement in the case of single user (SU) transmission or if a full bandwidth is multi user-multi input multi output (MU-MIMO) transmission. Hereinafter, a case where the second tone plan is a tone plan of the 320 MHz band, which has been newly defined in the 802.11be WLAN system is assumed and described.

The second tone plan includes 12 left guard tones, 11 right guard tones, 5 DC tones and a 4068 tone resource unit (RU). That is, the second tone plan may have the 12 left guard tones and the 11 right guard tones at both ends thereof and the 5 DC tones in the middle thereof, and the remaining band thereof may consist of the 4068 tone RU. The 4068 tone RU may include a data tone, a pilot tone and a null tone. The 4068 tone RU is an RU including 4068 tones.

The 320 MHz band may include first to fourth 80 MHz bands. The first 80 MHz band may be an 80 MHz band for the lowest frequency in the 320 MHz band. The second 80 MHz band may be an 80 MHz band for the second lowest frequency in the 320 MHz band. The third 80 MHz band may be an 80 MHz band for the third lowest frequency in the 320 MHz band. The fourth 80 MHz band may be an 80 MHz band for the highest frequency in the 320 MHz band. That is, the first tone plan may be configured as a tone plan in which a specific 80 MHz band has been punctured in the newly defined tone plan of the 320 MHz band.

For example, if the first tone plan is configured as a tone plan in which the first 80 MHz band has been punctured in the second tone plan. A third tone plan of the second 80 MHz band may be configured as a tone plan of the 80 MHz band defined in the 802.11ax WLAN system. In this case, a fourth tone plan of the third and fourth 80 MHz bands (the remaining 160 MHz band) may be configured as a tone plan having the 160 MHz band defined in the 802.11be WLAN system.

For another example, if the first tone plan is configured as a tone plan in which the second 80 MHz band has been punctured in the second tone plan, the third tone plan of the first 80 MHz band may be configured as a tone plan of the 80 MHz band defined in the 802.11ax WLAN system. The fourth tone plan of the third and fourth 80 MHz bands (the remaining 160 MHz band) may be configured as a tone plan having the 160 MHz band defined in the 802.11be WLAN system.

The fourth tone plan is a tone plan having the 160 MHz band, which has been newly defined in the 802.11be WLAN system. The fourth tone plan may include 12 left guard tones, 11 right guard tones, 5 DC tones and a 2020 tone RU. That is, the fourth tone plan may have the 12 left guard tones and the 11 right guard tones at both ends thereof and the 5 DC tones in the middle thereof, and the remaining band thereof may consist of the 2020 tone RU. The 2020 tone RU may include a data tone, a pilot tone and a null tone. The 2020 tone RU may be an RU including 2020 tones.

In the aforementioned two embodiments, there is proposed a method in which when one 80 MHz band is punctured in a primary 160 MHz band of the 320 MHz band, another 80 MHz band is substituted with an 80 MHz tone plan in the 802.11ax WLAN system and the remaining secondary 160 MHz band is configured as a 160 MHz tone plan defined in the 802.11be WLAN system.

Furthermore, for another example, if the first tone plan is configured as a tone plan in which the third 80 MHz band has been punctured in the second tone plan, the third tone plan of the fourth 80 MHz band may be configured as a tone plan of the 80 MHz band defined in the 802.11ax WLAN system. The fourth tone plan of the first and second 80 MHz bands (the remaining 160 MHz band) may be configured as a tone plan having the 160 MHz band defined in the 802.11be WLAN system.

Furthermore, for another example, if the first tone plan is configured as a tone plan in which the fourth 80 MHz band has been punctured in the second tone plan, the third tone plan of the third 80 MHz band may be configured as a tone plan of the 80 MHz band defined in the 802.11ax WLAN system. The fourth tone plan of the first and second 80 MHz bands (the remaining 160 MHz band) may be configured as a tone plan having the 160 MHz band defined in the 802.11be WLAN system.

The fourth tone plan is a tone plan having the 160 MHz band, which has been newly defined in the 802.11be WLAN system. The fourth tone plan may include 12 left guard tones, 11 right guard tones, 5 DC tones and a 2020 tone RU. That is, the fourth tone plan may have the 12 left guard tones and the 11 right guard tones at both ends thereof and the 5 DC tones in the middle thereof, and the remaining band thereof may consist of the 2020 tone RU. The 2020 tone RU may include a data tone, a pilot tone and a null tone. The 2020 tone RU is an RU including 2020 tones.

In the aforementioned two embodiments, there is proposed a method in which when one 80 MHz band is punctured in a secondary 160 MHz band of the 320 MHz band, another 80 MHz band is substituted with an 80 MHz tone plan of the 802.11ax WLAN system and the remaining primary 160 MHz band thereof is configured as a 160 MHz tone plan defined in the 802.11be WLAN system.

Furthermore, the tone plan of the 80 MHz band defined in the 802.11ax WLAN system, may be a 996 tone RU. The 996 tone RU is an RU including 996 tones.

Information on the first tone plan may include allocation information for an RU included in the first tone plan. The data field may be received through the RU.

The PPDU may include a first field supported in the 802.11be WLAN system and a second field supported in the legacy WLAN system.

The first field may include first and second SIG fields.

For example, the first SIG field may be an EHT-SIG-A field. A bandwidth (BW) field of the EHT-SIG-A field may include information on a bandwidth in which the PPDU is transmitted.

For another example, the first SIG field may be a universal-signal (U-SIG) field, and the second SIG field may be an EHT-SIG field. In this case, the second SIG field may include information on a preamble puncturing pattern of the wideband. That is, the transmitting STA may signal the bandwidth of the wideband based on the U-SIG field, and may signal the preamble puncturing pattern of the wideband based on the EHT-SIG field.

The PPDU may further include a legacy-signal (L-SIG) field, a repeated legacy-signal (RL-SIG) field, an EHT-short training field (EHT-STF), an EHT-long training field (EHT-LTF), and a data field. The EHT-SIG field may include an EHT-SIG-A field and an EHT-SIG-B field. The EHT-SIG field may further include an EHT-SIG-C field.

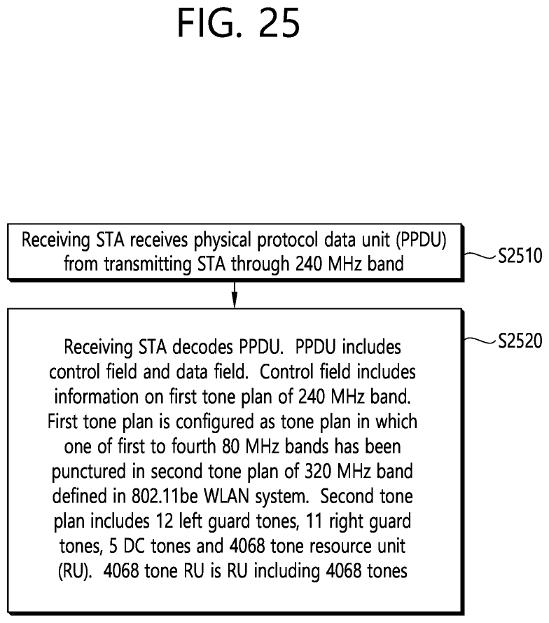

FIG. 25 is a flowchart illustrating a procedure of receiving, by a Receiving STA, a PPDU in a wideband according to the present embodiment.

An example of FIG. 25 may be performed in a network environment in which a next-generation WLAN system (IEEE 802.11be or EHT WLAN system) is supported. The next-generation WLAN system may satisfy backward compatibility with an 802.11ax system as a WLAN system improved from the 802.11ax system.

The example of FIG. 25 may be performed in a Receiving STA, and may correspond to an STA supporting an extremely high throughput (EHT) WLAN system. A transmitting STA in FIG. 25 may correspond to an access point (AP).

The present embodiment proposes a method of configuring a tone plan for transmitting a PPDU in widebands (240 MHz and 320 MHz bands) supported in an EHT WLAN system. In particular, the present embodiment proposes a method of configuring a tone plan having a 240 MHz band by performing 80 MHz puncturing on a tone plan of a 320 MHz band and transmitting and receiving PPDUs.

In step S2510, the Receiving Station (STA) receives a physical protocol data unit (PPDU) from the transmitting STA through the 240 MHz band.

In step S2520, the Receiving STA decodes the PPDU.

The control field includes information on a first tone plan of the 240 MHz band. The first tone plan is configured as a tone plan in which one of first to fourth 80 MHz bands has been punctured in a second tone plan of the 320 MHz band defined in the 802.11be WLAN system. The first tone plan may be used in order to transmit the PPDU regardless of whether the 240 MHz band is continuous or non-continuous.

The second tone plan may be a tone plan of the 320 MHz band, which has been newly defined in the 802.11be WLAN system, or may be a tone plan obtained by twice repeating a tone plan having the 160 MHz band, which has been newly defined in the 802.11be WLAN system. The second tone plan has been defined for throughput improvement in the case of single user (SU) transmission or if a full bandwidth is multi user-multi input multi output (MU-MIMO) transmission. Hereinafter, a case where the second tone plan is a tone plan of the 320 MHz band, which has been newly defined in the 802.11be WLAN system, is assumed and described.

The second tone plan includes 12 left guard tones, 11 right guard tones, 5 DC tones and a 4068 tone resource unit (RU). That is, the second tone plan may have the 12 left guard tones and the 11 right guard tones at both ends thereof and the 5 DC tones in the middle thereof, and the remaining band thereof may consist of the 4068 tone RU. The 4068 tone RU may include a data tone, a pilot tone and a null tone. The 4068 tone RU is an RU including 4068 tones.

the 320 MHz band may include first to fourth 80 MHz bands. The first 80 MHz band may be an 80 MHz band for the lowest frequency of the 320 MHz band. The second 80 MHz band may be an 80 MHz band for the second lowest frequency of the 320 MHz band. The third 80 MHz band may be an 80 MHz band for the third lowest frequency of the 320 MHz band. The fourth 80 MHz band may be an 80 MHz band for the highest frequency of the 320 MHz band. That is, the first tone plan may be configured as a tone plan in which a specific 80 MHz band has been punctured in the newly defined tone plan of the 320 MHz band.

For example, if the first tone plan is configured as a tone plan in which the first 80 MHz band has been punctured in the second tone plan. A third tone plan of the second 80 MHz band may be configured as a tone plan of the 80 MHz band defined in the 802.11ax WLAN system. In this case, a fourth tone plan of the third and fourth 80 MHz bands (the remaining 160 MHz band) may be configured as a tone plan having the 160 MHz band defined in the 802.11be WLAN system.

For another example, if the first tone plan is configured as a tone plan in which the second 80 MHz band has been punctured in the second tone plan, the third tone plan of the first 80 MHz band may be configured as a tone plan of the 80 MHz band defined in the 802.11ax WLAN system. The fourth tone plan of the third and fourth 80 MHz bands (the remaining 160 MHz band) may be configured as a tone plan having the 160 MHz band defined in the 802.11be WLAN system.

The fourth tone plan is a tone plan having the 160 MHz band, which has been newly defined in the 802.11be WLAN system, and the fourth tone plan may include 12 left guard tones, 11 right guard tones, 5 DC tones and a 2020 tone RU. That is, the fourth tone plan may have the 12 left guard tones and the 11 right guard tones at both ends thereof and the 5 DC tones in the middle thereof, and the remaining band thereof may consist of a 2020 tone RU. The 2020 tone RU may include a data tone, a pilot tone and a null tone. The 2020 tone RU is an RU including 2020 tones.

In the aforementioned two embodiments, there is proposed a method in which if one 80 MHz band is punctured in a primary 160 MHz band of the 320 MHz band, another 80 MHz band is substituted with an 80 MHz tone plan of the 802.11ax WLAN system and the remaining secondary 160 MHz band is configured as a 160 MHz tone plan defined in the 802.11be WLAN system.

Furthermore, for another example, if the first tone plan is configured as a tone plan in which the third 80 MHz band has been punctured in the second tone plan, the third tone plan of the fourth 80 MHz band may be configured as a tone plan of the 80 MHz band defined in the 802.11ax WLAN system. The fourth tone plan of the first and second 80 MHz bands (the remaining 160 MHz band) may be configured as a tone plan having the 160 MHz band defined in the 802.11be WLAN system.

Furthermore, for another example, if the first tone plan is configured as a tone plan in which the fourth 80 MHz band has been punctured in the second tone plan, the third tone plan of the third 80 MHz band may be configured as a tone plan of the 80 MHz band defined in the 802.11ax WLAN system. The fourth tone plan of the first and second 80 MHz bands (the remaining 160 MHz band) may be configured as a tone plan having the 160 MHz band defined in the 802.11be WLAN system.

the fourth tone plan is a tone plan having the 160 MHz band, which has been newly defined in the 802.11be WLAN system, and the fourth tone plan may include 12 left guard tones, 11 right guard tones, 5 DC tones and a 2020 tone RU. That is, the fourth tone plan may have the 12 left guard tones and the 11 right guard tones at both ends thereof and the 5 DC tones in the middle thereof, and the remaining band thereof may consist of a 2020 tone RU. The 2020 tone RU may include a data tone, a pilot tone and a null tone. The 2020 tone RU is an RU including 2020 tones.

In the aforementioned two embodiments, there is proposed a method in which if one 80 MHz band is punctured in a secondary 160 MHz band of the 320 MHz band, another 80 MHz band is substituted with an 80 MHz tone plan of the 802.11ax WLAN system and the remaining primary 160 MHz band thereof is configured as a 160 MHz tone plan defined in the 802.11be WLAN system.

Furthermore, the tone plan of the 80 MHz band defined in the 802.11ax WLAN system, may be a 996 tone RU. The 996 tone RU is an RU including 996 tones.

Information on the first tone plan may include allocation information for an RU included in the first tone plan. The data field may be received through the RU.

The PPDU may include a first field supported in the 802.11be WLAN system and a second field supported in the legacy WLAN system.

The first field may include first and second SIG fields.

For example, the first SIG field may be an EHT-SIG-A field. A bandwidth (BW) field of the EHT-SIG-A field may include information on a bandwidth in which the PPDU is transmitted.

For another example, the first SIG field may be a universal-signal (U-SIG) field, and the second SIG field may be an EHT-SIG field. In this case, the second SIG field may include information on a preamble puncturing pattern of the wideband. That is, the transmitting STA may signal the bandwidth of the wideband based on the U-SIG field, and may signal the preamble puncturing pattern of the wideband based on the EHT-SIG field.

The PPDU may further include a legacy-signal (L-SIG) field, a repeated legacy-signal (RL-SIG) field, an EHT-short training field (EHT-STF), an EHT-long training field (EHT-LTF), and a data field. The EHT-SIG field may include an EHT-SIG-A field and an EHT-SIG-B field. The EHT-SIG field may further include an EHT-SIG-C field.

4. Device Configuration

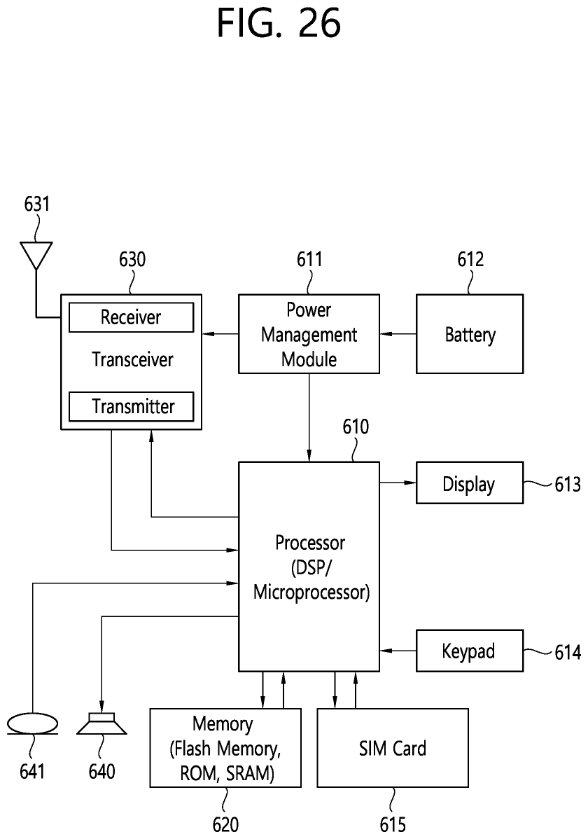

FIG. 26 illustrates an example of a modified transmission device and/or reception device of this specification.

Each device/STA shown in sub-figures (a)/(b) of FIG. 1 may be modified as shown in FIG. 26. A transceiver 630 of FIG. 26 may be the same as the transceiver(s) 113 and 123 of FIG. 1. The transceiver 630 of FIG. 26 may include a receiver and a transmitter.

A processor 610 of FIG. 26 may be the same as the processor(s) 111 and 121 shown in FIG. 1. Alternatively, the processor 610 of FIG. 26 may be the same as the processing chip(s) 114 and 124 shown in FIG. 1.

A memory 150 of FIG. 26 may be the same as the memory(s) 112 and 122 shown in FIG. 1. Alternatively, the memory 150 of FIG. 26 may be a separate external memory that is different from the memory(s) 112 and 122 shown in FIG. 1.

Referring to FIG. 26, the power management module 611 manages power for the processor 610 and/or the transceiver 630. The battery 612 supplies power to the power management module 611. The display 613 outputs results processed by the processor 610. The keypad 614 receives inputs that are to be used by the processor 610. The keypad 614 may be shown on the display 613. The SIM card 615 may be an integrated circuit that is intended to securely store the international mobile subscriber identity (IMSI) number and its related key, which are used to identify and authenticate subscribers on mobile telephony devices, such as mobile phones and computers.

Referring to FIG. 26, the speaker 640 may output sound-related results processed by the processor 610. The microphone 641 may receive sound-related inputs to be used by the processor 610.

The above-described technical features of this specification may be applied to various devices and methods. For example, the above-described technical features of this specification may be performed/supported through the device(s) of FIG. 1 and/or FIG. 26. For example, the above-described technical features of this specification may be applied to only part of FIG. 1 and/or FIG. 26. For example, the above-described technical features of this specification may be implemented based on the processing chip(s) 114 and 124 of FIG. 1, or implemented based on the processor(s) 111 and 121 and the memory(s) 112 and 122, or implemented based on the processor 610 and the memory 620 of FIG. 26. For example, the device according to this specification receives a Physical Protocol Data Unit (PPDU) from a transmitting Station (STA) through a wideband, and decodes the PPDU.

The PPDU includes a control field and a data field.

The control field includes information on the first tone plan of the 240 MHz band. The first tone plan is configured as a tone plan in which one of the first to fourth 80 MHz bands has been punctured in the second tone plan of the 320 MHz band defined in the 802.11be WLAN system. The first tone plan may be used in order to transmit the PPDU regardless of whether the 240 MHz band is continuous or non-continuous.

The second tone plan may be a tone plan of the 320 MHz band, which has been newly defined in the 802.11be WLAN system, or may be a tone plan obtained by twice repeating the 160 MHz band, which has been newly defined in the 802.11be WLAN system. The second tone plan has been defined for throughput improvement in the case of single user (SU) transmission or if a full bandwidth is multi user-multi input multi output (MU-MIMO) transmission. Hereinafter, a case where the second tone plan is a tone plan of the 320 MHz band, which has been newly defined in the 802.11be WLAN system, is assumed and described.

The second tone plan includes 12 left guard tones, 11 right guard tones, 5 DC tones and a 4068 tone resource unit (RU). That is, the second tone plan may have the 12 left guard tones and the 11 right guard tones at both ends thereof and the 5 DC tones in the middle thereof, and the remaining band thereof may consist of the 4068 tone RU. The 4068 tone RU may include a data tone, a pilot tone and a null tone. The 4068 tone RU is an RU including 4068 tones.

The 320 MHz band may include first to fourth 80 MHz bands. The first 80 MHz band may be an 80 MHz band for the lowest frequency of the 320 MHz band. The second 80 MHz band may be an 80 MHz band for the second lowest frequency of the 320 MHz band. The third 80 MHz band may be an 80 MHz band for the third lowest frequency of the 320 MHz band. The fourth 80 MHz band may be an 80 MHz band for the highest frequency of the 320 MHz band. That is, the first tone plan may be configured as a tone plan in which a specific 80 MHz band has been punctured in the newly defined tone plan of the 320 MHz band.

For example, if the first tone plan is configured as a tone plan in which the first 80 MHz band has been punctured in the second tone plan. A third tone plan of the second 80 MHz band may be configured as a tone plan of the 80 MHz band defined in the 802.11ax WLAN system. In this case, a fourth tone plan of the third and fourth 80 MHz bands (the remaining 160 MHz band) may be configured as a tone plan having the 160 MHz band defined in the 802.11be WLAN system.

For another example, if the first tone plan is configured as a tone plan in which the second 80 MHz band has been punctured in the second tone plan, the third tone plan of the first 80 MHz band may be configured as a tone plan of the 80 MHz band defined in the 802.11ax WLAN system. The fourth tone plan of the third and fourth 80 MHz bands (the remaining 160 MHz band) may be configured as a tone plan having the 160 MHz band defined in the 802.11be WLAN system.

The fourth tone plan is a tone plan having the 160 MHz band, which has been newly defined in the 802.11be WLAN system, and the fourth tone plan may include 12 left guard tones, 11 right guard tones, 5 DC tones and a 2020 tone RU. That is, the fourth tone plan may have the 12 left guard tones and the 11 right guard tones at both ends thereof and the 5 DC tones in the middle thereof, and the remaining band thereof may consist of a 2020 tone RU. The 2020 tone RU may include a data tone, a pilot tone and a null tone. The 2020 tone RU is an RU including 2020 tones.

In the aforementioned two embodiments, there is proposed a method in which if one 80 MHz band is punctured in a primary 160 MHz band of the 320 MHz band, another 80 MHz band is substituted with an 80 MHz tone plan of the 802.11ax WLAN system and the remaining secondary 160 MHz band thereof is configured as a 160 MHz tone plan defined in the 802.11be WLAN system.

Furthermore, for another example, if the first tone plan is configured as a tone plan in which the third 80 MHz band has been punctured in the second tone plan, the third tone plan of the fourth 80 MHz band may be configured as a tone plan of the 80 MHz band defined in the 802.11ax WLAN system. The fourth tone plan of the first and second 80 MHz bands (the remaining 160 MHz band) may be configured as a tone plan having the 160 MHz band defined in the 802.11be WLAN system.

Furthermore, for another example, if the first tone plan is configured as a tone plan in which the fourth 80 MHz band has been punctured in the second tone plan, the third tone plan of the third 80 MHz band may be configured as a tone plan of the 80 MHz band defined in the 802.11ax WLAN system. The fourth tone plan of the first and second 80 MHz bands (the remaining 160 MHz band) may be configured as a tone plan having the 160 MHz band defined in the 802.11be WLAN system.

The fourth tone plan is a tone plan having the 160 MHz band, which has been newly defined in the 802.11be WLAN system, and the fourth tone plan may include 12 left guard tones, 11 right guard tones, 5 DC tones and a 2020 tone RU. That is, the fourth tone plan may have the 12 left guard tones and the 11 right guard tones at both ends thereof and the 5 DC tones in the middle thereof, and the remaining band thereof may consist of a 2020 tone RU. The 2020 tone RU may include a data tone, a pilot tone and a null tone. The 2020 tone RU is an RU including 2020 tones.

In the aforementioned two embodiments, there is proposed a method in which if one 80 MHz band is punctured in a secondary 160 MHz band of the 320 MHz band, another 80 MHz band is substituted with an 80 MHz tone plan of the 802.11ax WLAN system, and the remaining primary 160 MHz band thereof is configured as a 160 MHz tone plan defined in the 802.11be WLAN system.

Furthermore, the tone plan of the 80 MHz band defined in the 802.11ax WLAN system, may be a 996 tone RU. The 996 tone RU is an RU including 996 tones.

Information on the first tone plan may include allocation information for an RU included in the first tone plan. The data field may be received through the RU.

The PPDU may include a first field supported in the 802.11be WLAN system and a second field supported in the legacy WLAN system.

The first field may include first and second SIG fields.

For example, the first SIG field may be an EHT-SIG-A field. A bandwidth (BW) field of the EHT-SIG-A field may include information on a bandwidth in which the PPDU is transmitted.

For another example, the first SIG field may be a universal-signal (U-SIG) field, and the second SIG field may be an EHT-SIG field. In this case, the second SIG field may include information on a preamble puncturing pattern of the wideband. That is, the transmitting STA may signal the bandwidth of the wideband based on the U-SIG field, and may signal the preamble puncturing pattern of the wideband based on the EHT-SIG field.

The PPDU may further include a legacy-signal (L-SIG) field, a repeated legacy-signal (RL-SIG) field, an EHT-short training field (EHT-STF), an EHT-long training field (EHT-LTF), and a data field. The EHT-SIG field may include an EHT-SIG-A field and an EHT-SIG-B field. The EHT-SIG field may further include an EHT-SIG-C field.

A technical characteristic of the present disclosure may be implemented based on a computer readable medium (CRM). For example, the CRM proposed by the present disclosure may be at least one computer-readable medium including an instruction based on being executed by at least one processor.

The CRM may store instructions which perform operations including steps of receiving a physical protocol data unit (PPDU) from a transmitting STA through a 240 MHz band; and decoding the PPDU. The instructions stored in the CRM of the present disclosure may be executed by at least one processor. The at least one processor related to the CRM of the present disclosure may be the processor 111, 121 or the processing chip 114, 124 of FIG. 1 or the processor 610 of FIG. 26. Meanwhile, the CRM of the present disclosure may be the memory 112, 122 of FIG. 1 or the memory 620 of FIG. 26 or a separate external memory/storage medium/disk, etc.

The PPDU includes a control field and a data field.

The control field includes information on a first tone plan of the 240 MHz band. The first tone plan is configured as a tone plan in which one of first to fourth 80 MHz bands has been punctured in a second tone plan of the 320 MHz band defined in the 802.11be WLAN system. The first tone plan may be used in order to transmit the PPDU regardless of whether the 240 MHz band is continuous or non-continuous.

The second tone plan may be a tone plan of the 320 MHz band, which has been newly defined in the 802.11be WLAN system, or may be a tone plan obtained by twice repeating the 160 MHz band, which has been newly defined in the 802.11be WLAN system. The second tone plan has been defined for throughput improvement in the case of single user (SU) transmission or if a full bandwidth is multi user-multi input multi output (MU-MIMO) transmission. Hereinafter, the second tone plan is a tone plan of the 320 MHz band, which has been newly defined in the 802.11be WLAN system, [symbol] assuming a case where [symbol] is described.

The second tone plan includes 12 left guard tones, 11 right guard tones, 5 DC tones and a 4068 tone resource unit (RU). That is, the second tone plan may have the 12 left guard tones and the 11 right guard tones at both ends thereof and the 5 DC tones in the middle thereof, and the remaining band thereof may consist of the 4068 tone RU. The 4068 tone RU may include a data tone, a pilot tone and a null tone. The 4068 tone RU is an RU including 4068 tones.

The 320 MHz band may include first to fourth 80 MHz bands. The first 80 MHz band may be an 80 MHz band for the lowest frequency of the 320 MHz band. The second 80 MHz band may be an 80 MHz band for the second lowest frequency of the 320 MHz band. The third 80 MHz band may be an 80 MHz band for the third lowest frequency of the 320 MHz band. The fourth 80 MHz band may be an 80 MHz band for the highest frequency of the 320 MHz band. That is, the first tone plan may be configured as a tone plan in which a specific 80 MHz band has been punctured in the newly defined tone plan of the 320 MHz band.

For example, if the first tone plan is configured as a tone plan in which the first 80 MHz band has been punctured in the second tone plan. A third tone plan of the second 80 MHz band may be configured as a tone plan of the 80 MHz band defined in the 802.11ax WLAN system. In this case, a fourth tone plan of the third and fourth 80 MHz bands (the remaining 160 MHz band) may be configured as a tone plan having the 160 MHz band defined in the 802.11be WLAN system.

For another example, if the first tone plan is configured as a tone plan in which the second 80 MHz band has been punctured in the second tone plan, the third tone plan of the first 80 MHz band may be configured as a tone plan of the 80 MHz band defined in the 802.11ax WLAN system. The fourth tone plan of the third and fourth 80 MHz bands (the remaining 160 MHz band) may be configured as a tone plan having the 160 MHz band defined in the 802.11be WLAN system.

The fourth tone plan is a tone plan having the 160 MHz band, which has been newly defined in the 802.11be WLAN system, and the fourth tone plan may include 12 left guard tones, 11 right guard tones, 5 DC tones and a 2020 tone RU. That is, the fourth tone plan may have the 12 left guard tones and the 11 right guard tones at both ends thereof and the 5 DC tones in the middle thereof, and the remaining band thereof may consist of a 2020 tone RU. The 2020 tone RU may include a data tone, a pilot tone and a null tone. The 2020 tone RU is an RU including 2020 tones.

In the aforementioned two embodiments, there is proposed a method in which if one 80 MHz band is punctured in a primary 160 MHz band of the 320 MHz band, another 80 MHz band is substituted with an 80 MHz tone plan of the 802.11ax WLAN system, and the remaining secondary 160 MHz band thereof is configured as a 160 MHz tone plan defined in the 802.11be WLAN system.

Furthermore, for another example, if the first tone plan is configured as a tone plan in which the third 80 MHz band has been punctured in the second tone plan, the third tone plan of the fourth 80 MHz band may be configured as a tone plan of the 80 MHz band defined in the 802.11ax WLAN system. The fourth tone plan of the first and second 80 MHz bands (the remaining 160 MHz band) may be configured as a tone plan having the 160 MHz band defined in the 802.11be WLAN system.

Furthermore, for another example, if the first tone plan is configured as a tone plan in which the fourth 80 MHz band has been punctured in the second tone plan, the third tone plan of the third 80 MHz band may be configured as a tone plan of the 80 MHz band defined in the 802.11ax WLAN system. The fourth tone plan of the first and second 80 MHz bands (the remaining 160 MHz band) may be configured as a tone plan having the 160 MHz band defined in the 802.11be WLAN system.

The fourth tone plan is a tone plan having the 160 MHz band, which has been newly defined in the 802.11be WLAN system, and the fourth tone plan may include 12 left guard tones, 11 right guard tones, 5 DC tones and a 2020 tone RU. That is, the fourth tone plan may have the 12 left guard tones and the 11 right guard tones at both ends thereof and the 5 DC tones in the middle thereof, and the remaining band thereof may consist of a 2020 tone RU. The 2020 tone RU may include a data tone, a pilot tone and a null tone. The 2020 tone RU is an RU including 2020 tones.

In the aforementioned two embodiments, there is proposed a method in which if one 80 MHz band is punctured in a secondary 160 MHz band of the 320 MHz band, another 80 MHz band is substituted with an 80 MHz tone plan of the 802.11ax WLAN system, and the remaining primary 160 MHz band is configured as a 160 MHz tone plan defined in the 802.11be WLAN system.

Furthermore, the tone plan of the 80 MHz band defined in the 802.11ax WLAN system, may be a 996 tone RU. The 996 tone RU is an RU including 996 tones.

Information on the first tone plan may include allocation information for an RU included in the first tone plan. The data field may be received through the RU.

The PPDU may include a first field supported in the 802.11be WLAN system and a second field supported in the legacy WLAN system.

The first field may include first and second SIG fields.

For example, the first SIG field may be an EHT-SIG-A field. A bandwidth (BW) field of the EHT-SIG-A field may include information on a bandwidth in which the PPDU is transmitted.

For another example, the first SIG field may be a universal-signal (U-SIG) field, and the second SIG field may be an EHT-SIG field. In this case, the second SIG field may include information on a preamble puncturing pattern of the wideband. That is, the transmitting STA may signal the bandwidth of the wideband based on the U-SIG field, and may signal the preamble puncturing pattern of the wideband based on the EHT-SIG field.

The PPDU may further include a legacy-signal (L-SIG) field, a repeated legacy-signal (RL-SIG) field, an EHT-short training field (EHT-STF), an EHT-long training field (EHT-LTF), and a data field. The EHT-SIG field may include an EHT-SIG-A field and an EHT-SIG-B field. The EHT-SIG field may further include an EHT-SIG-C field.

The foregoing technical features of this specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims recited in this specification may be combined in a variety of ways. For example, the technical features of the method claims of this specification may be combined to be implemented as a device, and the technical features of the device claims of this specification may be combined to be implemented by a method. In addition, the technical characteristics of the method claim of this specification and the technical characteristics of the device claim may be combined to be implemented as a device, and the technical characteristics of the method claim of this specification and the technical characteristics of the device claim may be combined to be implemented by a method.

1. A method in a WLAN system, comprising:
receiving, by a Receiving Station (STA), a physical protocol data unit (PPDU) from a transmitting STA through a 240 MHz band; and
decoding, by the Receiving STA, the PPDU,
wherein the PPDU comprises a control field and a data field,
the control field comprises information on a first tone plan of the 240 MHz band,
the first tone plan is configured as a tone plan in which one of first to fourth 80 MHz bands has been punctured in a second tone plan of a 320 MHz band defined in an 802.11be WLAN system,
the second tone plan comprises 12 left guard tones, 11 right guard tones, 5 DC tones and a 4068 tone resource unit (RU), and
the 4068 tone RU is an RU comprising 4068 tones.

2. The method of claim 1, wherein:
the 320 MHz band comprises the first to fourth 80 MHz bands,
the first 80 MHz band is an 80 MHz band for a lowest frequency of the 320 MHz band,
the second 80 MHz band is an 80 MHz band for a second lowest frequency of the 320 MHz band,
the third 80 MHz band is an 80 MHz band for a third lowest frequency of the 320 MHz band, and
the fourth 80 MHz band is an 80 MHz band for a highest frequency of the 320 MHz band.

3. The method of claim 2, wherein:
if the first tone plan is configured as a tone plan in which the first 80 MHz band has been punctured in the second tone plan,
a third tone plan of the second 80 MHz band is configured as a tone plan of 80 MHz band defined in an 802.11ax WLAN system,
a fourth tone plan of the third and fourth 80 MHz bands is configured as a tone plan of a 160 MHz band defined in the 802.11be WLAN system,
the fourth tone plan comprises 12 left guard tones, 11 right guard tones, 5 DC tones and a 2020 tone RU, and
the 2020 tone RU is an RU comprising 2020 tones.

4. The method of claim 3, wherein:
the tone plan of the 80 MHz band defined in the 802.11ax WLAN system is a 996 tone RU, and
the 996 tone RU is an RU comprising 996 tones.

5. The method of claim 2, wherein:
if the first tone plan is configured as a tone plan in which the second 80 MHz band has been punctured in the second tone plan,
a third tone plan of the first 80 MHz band is configured as a tone plan of the 80 MHz band defined in an 802.11ax WLAN system,
a fourth tone plan of the third and fourth 80 MHz bands is configured as a tone plan of a 160 MHz band defined in the 802.11be WLAN system,
the fourth tone plan comprises 12 left guard tones, 11 right guard tones, 5 DC tones and a 2020 tone RU, and
the 2020 tone RU is an RU comprising 2020 tones.

6. The method of claim 2, wherein:
if the first tone plan is configured as a tone plan in which the third 80 MHz band has been punctured in the second tone plan,
a third tone plan of the fourth 80 MHz band is configured as a tone plan of the 80 MHz band defined in an 802.11ax WLAN system,
a fourth tone plan of the first and second 80 MHz bands is configured as a tone plan of a 160 MHz band defined in the 802.11be WLAN system,
the fourth tone plan comprises 12 left guard tones, 11 right guard tones, 5 DC tones and a 2020 tone RU, and
the 2020 tone RU is an RU comprising 2020 tones.

7. The method of claim 2, wherein:
if the first tone plan is configured as a tone plan in which the fourth 80 MHz band has been punctured in the second tone plan,
a third tone plan of the third 80 MHz band is configured as a tone plan of the 80 MHz band defined in an 802.11ax WLAN system,
a fourth tone plan of the first and second 80 MHz bands is configured as a tone plan of a 160 MHz band defined in the 802.11be WLAN system,
the fourth tone plan comprises 12 left guard tones, 11 right guard tones, 5 DC tones and a 2020 tone RU, and
the 2020 tone RU is an RU comprising 2020 tones.

8. The method of claim 1, wherein:
the information on the first tone plan comprises allocation information for an RU included in the first tone plan, and
the data field is received through the RU.

9. A Receiving Station (STA) in a WLAN system, comprising:
a memory;
a transceiver; and
a processor operately connected to the memory and the transceiver, wherein the processor is configured to:
receive a physical protocol data unit (PPDU) from a transmitting STA through a 240 MHz band; and
decode the PPDU,
wherein the PPDU comprises a control field and a data field,
the control field comprises information on a first tone plan of the 240 MHz band,
the first tone plan is configured as a tone plan in which one of first to fourth 80 MHz bands has been punctured in a second tone plan of a 320 MHz band defined in an 802.11be WLAN system,
the second tone plan comprises 12 left guard tones, 11 right guard tones, 5 DC tones and a 4068 tone resource unit (RU), and
the 4068 tone RU is an RU comprising 4068 tones the Receiving STA.

10. A method in a WLAN system, comprising:
generating, by a transmitting Station (STA), a physical protocol data unit (PPDU); and
transmitting, by the transmitting STA, the PPDU to a Receiving STA through a 240 MHz band,
wherein the PPDU comprises a control field and a data field,
the control field comprises information on a first tone plan of the 240 MHz band,
the first tone plan is configured as a tone plan in which one of first to fourth 80 MHz bands has been punctured in a second tone plan of a 320 MHz band defined in an 802.11be WLAN system,
the second tone plan comprises 12 left guard tones, 11 right guard tones, 5 DC tones and a 4068 tone resource unit (RU), and
the 4068 tone RU is an RU comprising 4068 tones.

11. The method of claim 10, wherein:
the 320 MHz band comprises the first to fourth 80 MHz bands,
the first 80 MHz band is an 80 MHz band for a lowest frequency of the 320 MHz band,
the second 80 MHz band is an 80 MHz band for a second lowest frequency of the 320 MHz band,
the third 80 MHz band is an 80 MHz band for a third lowest frequency of the 320 MHz band, and
the fourth 80 MHz band is an 80 MHz band for a highest frequency of the 320 MHz band.

12. The method of claim 11, wherein:
if the first tone plan is configured as a tone plan in which the first 80 MHz band has been punctured in the second tone plan,
a third tone plan of the second 80 MHz band is configured as a tone plan of 80 MHz band defined in an 802.11ax WLAN system,
a fourth tone plan of the third and fourth 80 MHz bands is configured as a tone plan of a 160 MHz band defined in the 802.11be WLAN system,
the fourth tone plan comprises 12 left guard tones, 11 right guard tones, 5 DC tones and a 2020 tone RU, and
the 2020 tone RU is an RU comprising 2020 tones.

13. The method of claim 12, wherein:
the tone plan of the 80 MHz band defined in the 802.11ax WLAN system, is a 996 tone RU, and
the 996 tone RU is an RU comprising 996 tones.

14. The method of claim 11, wherein:
if the first tone plan is configured as a tone plan in which the second 80 MHz band has been punctured in the second tone plan,
a third tone plan of the first 80 MHz band is configured as a tone plan of the 80 MHz band defined in an 802.11ax WLAN system,
a fourth tone plan of the third and fourth 80 MHz bands is configured as a tone plan of a 160 MHz band defined in the 802.11be WLAN system,
the fourth tone plan comprises 12 left guard tones, 11 right guard tones, 5 DC tones and a 2020 tone RU, and
the 2020 tone RU is an RU comprising 2020 tones.

15. The method of claim 11, wherein
if the first tone plan is configured as a tone plan in which the third 80 MHz band has been punctured in the second tone plan,
a third tone plan of the fourth 80 MHz band is configured as a tone plan of the 80 MHz band defined in an 802.11ax WLAN system,
a fourth tone plan of the first and second 80 MHz bands is configured as a tone plan of a 160 MHz band defined in the 802.11be WLAN system,
the fourth tone plan comprises 12 left guard tones, 11 right guard tones, 5 DC tones and a 2020 tone RU, and
the 2020 tone RU is an RU comprising 2020 tones.

16. The method of claim 11, wherein:
if the first tone plan is configured as a tone plan in which the fourth 80 MHz band has been punctured in the second tone plan,
a third tone plan of the third 80 MHz band is configured as a tone plan of the 80 MHz band defined in an 802.11ax WLAN system,
a fourth tone plan of the first and second 80 MHz bands is configured as a tone plan of a 160 MHz band defined in the 802.11be WLAN system,
the fourth tone plan comprises 12 left guard tones, 11 right guard tones, 5 DC tones and a 2020 tone RU, and
the 2020 tone RU is an RU comprising 2020 tones.

17. The method of claim 10, wherein:
the information on the first tone plan comprises allocation information for an RU included in the first tone plan, and
the data field is received through the RU.

18-20. (canceled)
